(19) United States
(12) Patent Application Publication
(10) Pub. No.: US 2008/0279259 A1
(43) Pub. Date: Nov. 13, 2008

(54) Radio Communication Apparatus, Base Station and System

(76) Inventors: Takahiro Kobayashi, Kawasaki-shi (JP); Noritaka Deguchi, Kawasaki-shi (JP); Yoshimasa Egashira, Kawasaki-shi (JP); Yasuhiko Tanabe, Kawasaki-shi (JP); Tsuguhide Aoki, Kawasaki-shi (JP); Manabu Mukai, Yokohama-shi (JP); Tomoya Horiguchi, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/136,528

(22) Filed: Jun. 10, 2008

Related U.S. Application Data
(63) Continuation of application No. 11/152,227, filed on Jun. 15, 2005.

(30) Foreign Application Priority Data
Jul. 16, 2004 (JP) 2004-210196

(51) Int. Cl. H04B 1/713

(52) U.S. Cl. 375/135; 375/E01.033

(57) ABSTRACT

Radio communication apparatus for receiving OFDM signal from base station and transmitting FH signal to base station, using sub-channels, base station comparing hopping pattern information items indicating hopping patterns from radio communication apparatuses including radio communication apparatus, and generating collision information when hopping patterns include colliding hopping patterns, includes estimation unit configured to estimate channel response values of sub-channels based on OFDM signal, selector which selects, from sub-channels, several sub-channels which have higher channel response values than a value, each of channel response values being expressed by power level, signal-to-noise power ratio, or signal-to-interference ratio, determination unit configured to determine hopping pattern from selected sub-channels, transmitter which transmits, to base station, hopping pattern information item indicating determined hopping pattern, receiver which receives collision information from base station, and correction unit configured to correct hopping pattern based on collision information.

### CROSS-REFERENCE TO RELATED APPLICATIONS

This application is a continuation of U.S. application Ser. No. 11/152,227 filed on Jun. 15, 2005, and in turn claims priority to Japanese Patent Application No. 2004-210196, filed Jul. 16, 2004, the entire contents of each of which are incorporated herein by reference.

### BACKGROUND OF THE INVENTION

1. Field of the Invention

The present invention relates to a radio communication apparatus, base station and system utilizing time division duplex (TDD), in which orthogonal frequency division multiplexing (OFDM) is used for signals (down-signals) transmitted from the base station to the radio communication apparatus, and frequency hopping (FH) is used for signals (up-signals) transmitted from the radio communication apparatus to the base station.

2. Description of the Related Art

In a system in which a single base station interactively communicates with a plurality of mobile stations, frequency hopping (FH) is utilized as a multiplexing scheme for commonly using a single frequency band. Frequency hopping realizes common use of a single frequency band by dividing the frequency band into a plurality of sub-channels, switching sub-channels assigned to the mobile stations in units of certain periods, and making different the order of use of sub-channels between the mobile stations.

Basically, the frequency hopping scheme equally uses all sub-channels. In this case, during the time spent for a sub-channel of a degraded propagation environment, the possibility of occurrence of a transmission error is strong. To reduce the transmission error rate, techniques have been proposed in which the propagation environment of each sub-channel is estimated, and a sub-channel of a degraded propagation environment is avoided.

Specifically, there is a system capable of dynamically switching sub-channels used. This system employs an interference wave detection circuit, and changes the currently used frequency-hopping scheme to another when the detection circuit detects an interference level not less than a predetermined value (see, for example, Jpn. Pat. Appln. KOKAI Publication No. 2001-358615). In other words, this system changes the currently used frequency-hopping pattern if interference exists in the pattern.

However, in the above prior art in which interference is avoided by changing a frequency-hopping pattern, it is difficult to suppress the occurrence itself of interference where the interference is caused by, for example, a transmitter that uses the same frequency-hopping pattern as the currently used one.

Further, there is a known scheme in which a base station has a plurality of antenna elements, and signals transmitted from the antenna elements are multiplied by weights to form transmission beams, thereby enhancing the received signal quality of each mobile station. To calculate the weights, it is necessary to detect the states of channel responses. However, if signals are transmitted from the mobile station utilizing frequency hopping, and if the frequency band used to transmit signals from the base station to the mobile stations is broader than that used to transmit signals from the mobile stations to the base station, information concerning the entire band for the transmission signals of the base station cannot be acquired at a time. If the frequency-hopping pattern is determined to use predetermined frequency intervals, the time needed to acquire the whole frequency band information can be reduced. However, it is necessary to perform interpolation concerning unused frequency bands. Mobile communication systems are used in a multi-path environment in which a plurality of reflected waves exist. Therefore, in particular, if a reflected wave having a great delay time exists, frequency selective fading occurs. The greater the delay time, the narrower the fluctuation interval in frequency. Accordingly, if the interval of interpolation is increased, an error due to interpolation is increased. In contrast, if the interpolation interval is reduced in accordance with the narrow fluctuation interval in frequency, the time required to obtain the information is inevitably increased.

### BRIEF SUMMARY OF THE INVENTION

In accordance with a first aspect of the invention, there is provided a radio communication apparatus for receiving an orthogonal frequency division multiplexing (OFDM) signal from a base station and transmitting a frequency hopping (FH) signal to the base station, using a plurality of sub-channels, the base station comparing a plurality of hopping pattern information items indicating hopping patterns from a plurality of radio communication apparatuses including the radio communication apparatus, and generating collision information when the hopping patterns include colliding hopping patterns, the apparatus comprising: an estimation unit configured to estimate a plurality of channel response values of the sub-channels based on the OFDM signal; a selector which selects, from the sub-channels, several sub-channels which have higher channel response values than a value, each of the channel response values being expressed by a power level, a signal-to-noise power ratio, or a signal-to-interference ratio; a determination unit configured to determine a hopping pattern from the selected sub-channels; a transmitter which transmits, to the base station, a hopping pattern information item indicating the determined hopping pattern; a receiver which receives the collision information from the base station; and a correction unit configured to correct the hopping pattern based on the collision information.

In accordance with a second aspect of the invention, there is provided a radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, using a plurality of sub-channels, the system comprising:

each of the radio communication apparatuses comprising: an estimation unit configured to estimate a plurality of channel response values of the sub-channels based on the OFDM signal; an acquisition unit configured to acquire a plurality of received signal levels for each of frequency bands from the estimated channel response values; a selector which selects, from the sub-channels, several sub-channels which have higher received signal levels than a value, each of the channel response values being expressed by a power level, a signal-to-noise power ratio, or a signal-to-interference ratio; a determination unit configured to determine a hopping pattern from the selected sub-channels; and a transmitter which transmits, to the base station, hopping pattern information indicating the determined hopping pattern,

the base station comprising: a receiver which receives the hopping pattern information from each of the radio communication apparatuses; a generator which generates collision information when detecting colliding hopping patterns which exist between the radio communication apparatuses, by comparing a plurality of hopping pattern information items from the radio communication apparatuses; and a transmitter which transmits the collision information to each of the radio communication apparatuses,

each of radio communication apparatuses further comprising: a receiver which receives the collision information from the base station; and a correction unit configured to correct the determined hopping pattern based on the collision information.

In accordance with a third aspect of the invention, there is provided a radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, using a plurality of sub-channels, the system comprising:

each of the radio communication apparatuses comprising: an estimation unit configured to estimate a plurality of channel response values of the sub-channels based on the OFDM signal; a selector which selects, from the sub-channels, several sub-channels which have higher channel response values than a value, each of the channel response values being expressed by a power level, a signal-to-noise power ratio, or a signal-to-interference ratio; and a transmitter which transmits, to the base station, sub-channel information indicating the selected sub-channels,

the base station comprising: a receiver which receives the sub-channel information from each of the radio communication apparatuses; a setting unit configured to set, based on the sub-channel information, a plurality of hopping patterns at the radio communication apparatuses to avoid collision between the hopping patterns; and a transmitter which transmits, to each of the radio communication apparatuses, hopping pattern information indicating the hopping patterns corresponding to the radio communication apparatus.

In accordance with a fourth aspect of the invention, there is provided a radio communication apparatus for receiving an orthogonal frequency division multiplexing (OFDM) signal from a base station, and transmitting a frequency hopping (FH) signal to the base station, the apparatus comprising: a storing unit configured to store a plurality of hopping patterns which are suitable for use; a measuring unit configured to measure a received signal characteristic of each sub-carrier included in the OFDM signal; an acquiring unit configured to acquire, from the storing unit, one of the hopping patterns which uses a frequency band determined to be unused from the received signal characteristic; and a transmitter which transmits a signal in accordance with the acquired hopping pattern.

In accordance with a fifth aspect of the invention, there is provided a radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, the system comprising:

each of the radio communication apparatuses comprising: a measuring unit configured to measure a received signal characteristic of each sub-carrier included in the OFDM signal; and a transmitter which transmits the measured received signal characteristic to the base station,

the base station comprising: a receiver which receives the transmitted received signal characteristic from each of the radio communication apparatuses; a storing unit configured to store a plurality of hopping patterns which are suitable for use; an acquiring unit configured to acquire, from the storing unit, one of the hopping patterns which uses a frequency band determined to be unused from the received signal characteristic; and a transmitter which transmits, to each of the radio communication apparatuses, hopping pattern information indicating the acquired hopping pattern.

In accordance with a sixth aspect of the invention, there is provided a radio communication apparatus for receiving an orthogonal frequency division multiplexing (OFDM) signal from a base station, and transmitting a frequency hopping (FH) signal to the base station, the apparatus comprising: a measuring unit configured to measure a received signal characteristic of each sub-carrier included in the OFDM signal; a storing unit configured to store a plurality of hopping patterns which are suitable for use; an acquiring unit configured to acquire, from the storing unit, one of the hopping patterns which uses a frequency band determined to be unused from the received signal characteristic; and a transmitter which transmits, to another radio communication apparatus, a signal for requesting communication using the acquired hopping pattern.

In accordance with an eighth aspect of the invention, there is provided a radio communication apparatus for receiving an orthogonal frequency division multiplexing (OFDM) signal from a base station, and transmitting a frequency hopping (FH) signal to the base station, the apparatus comprising: a transmitter which transmits, to another radio communication apparatus, a request signal to request hopping pattern information indicating a hopping pattern used by the another radio communication apparatus; a receiver which receives the hopping pattern information from the another radio communication apparatus; a measuring unit configured to measure a received signal characteristic of each sub-carrier included in the OFDM signal; a storing unit configured to store a plurality of hopping patterns which are suitable for use; an acquiring unit configured to acquire, from the storing unit, a plurality of hopping patterns which uses a plurality of frequency bands determined to be unused from the received signal characteristic; and an informing unit configured to inform the another radio communication apparatus that communication is performed using a common hopping pattern, if the common hopping pattern is determined to exist between the acquired hopping patterns and the hopping pattern information.

In accordance with a ninth aspect of the invention, there is provided a radio communication apparatus for receiving an orthogonal frequency division multiplexing (OFDM) signal from a base station, and transmitting a frequency hopping (FH) signal to the base station, the apparatus comprising: an estimation unit configured to estimate a maximum delay period of a delay wave contained in the OFDM signal; a determination unit configured to determine a hopping pattern to enlarge intervals between sub-channels in proportion to an inverse of the maximum delay period; and a transmitter which transmits data to the base station using the determined hopping pattern.

In accordance with a tenth aspect of the invention, there is provided a radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, using a plurality of sub-channels, the system comprising:

each of the radio communication apparatuses comprising: an estimation unit configured to estimate a maximum delay period of a delay wave contained in the OFDM signal; a determination unit configured to determine a hopping pattern to enlarge intervals between the sub-channels in proportion to an inverse of the maximum delay period; and a transmitter which transmits data to the base station using the hopping pattern,

the base station comprising: a receiver which receives a signal transmitted from the each of the radio communication apparatuses using the hopping pattern; an estimation unit configured to estimate a plurality of channel response values based on the received signal; a calculator which calculates a plurality of weights for sub-carrier signals to be transmitted, based on the channel response values; and a multiplication unit configured to multiply the sub-carrier signals by corresponding weights.

### BRIEF DESCRIPTION OF THE SEVERAL VIEWS OF THE DRAWING

FIG. 1 is a view illustrating base stations and mobile stations according to embodiments of the invention;

FIG. 2A is a graph illustrating an OFDM signal as a down-signal;

FIG. 2B is a graph illustrating an FH signal as an up-signal;

FIG. 3 is a view illustrating a low-rate FH scheme;

FIG. 4 is a view illustrating a high-rate FH scheme;

FIG. 5 is a block diagram illustrating a radio communication apparatus according to a first embodiment;

FIG. 6 is a block diagram illustrating a radio base station according to the first embodiment;

FIG. 7 is a view illustrating examples of channel response values acquired by the channel response estimation unit appearing in FIG. 5 and examples of sub-channels selected by the sub-channel selector appearing in FIG. 5;

FIG. 8 is a view illustrating examples of frequency-hopping pattern collisions detected by the collision state information extraction unit appearing in FIG. 5;

FIG. 9 is a flowchart useful in explaining the process of determining a frequency-hopping pattern by each mobile station based on collision state information;

FIG. 10 is a view useful in explaining the operations of each base station and mobile station performed to update the frequency-hopping pattern in the first embodiment;

FIG. 11 is a view illustrating examples of sub-channels dedicated to the transmission of hopping-pattern information;

FIG. 12 is a block diagram illustrating a radio communication apparatus according to a second embodiment;

FIG. 13 is a block diagram illustrating a radio base station according to the second embodiment;

FIG. 14 is a flowchart useful in explaining the process of determining a frequency-hopping pattern by each base station based on collision state information;

FIG. 15 is a view useful in explaining the operations of each base station and mobile station performed to update the frequency-hopping pattern in the second embodiment;

FIG. 16 is a block diagram illustrating a radio communication apparatus according to a third embodiment;

FIG. 17 is a flowchart useful in explaining the operation of the radio communication apparatus of the third embodiment from the start of transmission to the end of transmission;

FIG. 18 is a flowchart useful in explaining, in more detail, the processing of transmission appearing in FIG. 17;

FIG. 19 is a view illustrating a preferable example according to the third embodiment of the invention;

FIG. 20 is a view illustrating a frequency-hopping pattern example that is applied to the radio communication system of the third embodiment;

FIG. 21A is a view illustrating a determination example at time T1;

FIG. 21B is a view illustrating a determination example at time T2;

FIG. 21C is a view illustrating a determination example at time T3;

FIG. 21D is a view illustrating a determination example at time T4;

FIG. 22 is a view illustrating the operations of a radio communication apparatus and base station according to a fourth embodiment of the invention;

FIG. 23 is a view illustrating a typical configuration example of a radio base station and radio communication apparatuses according to a fifth embodiment;

FIG. 24 is a view illustrating the operations of the radio base station and radio communication apparatuses according to the fifth embodiment;

FIG. 25 is a view illustrating other operation examples similar to those of FIG. 24;

FIG. 26 is a block diagram illustrating a radio communication apparatus according to a sixth embodiment;

FIG. 27A is a block diagram illustrating in more detail the maximum-delay estimation unit appearing in FIG. 26;

FIG. 27B is a graph useful in explaining a process example for determining a maximum delay time using the estimation unit of FIG. 27A;

FIG. 28A is a view illustrating a frequency-hopping pattern assumed when the maximum delay period of a delayed wave is short;

FIG. 28B is a view illustrating a frequency-hopping pattern assumed when the maximum delay period of a delayed wave is long;

FIG. 29 is a block diagram illustrating a radio base station according to the sixth embodiment;

FIG. 30 is a block diagram illustrating an example of the channel response estimation unit appearing in FIG. 29;

FIG. 31 is a view illustrating the channel response acquired by interpolation using the channel response estimation unit of FIG. 30;

FIG. 32 is a block diagram illustrating another example of the channel response estimation unit;

FIG. 33 is a block diagram illustrating the weight multiplier appearing in FIG. 29; and

FIG. 34 is a view illustrating a manner of sub-carrier grouping by the weight multiplier of FIG. 33.

### DETAILED DESCRIPTION OF THE INVENTION

Radio communication apparatuses, radio base stations and radio communication systems according to embodiments of the invention will be described in detail with reference to the accompanying drawings.

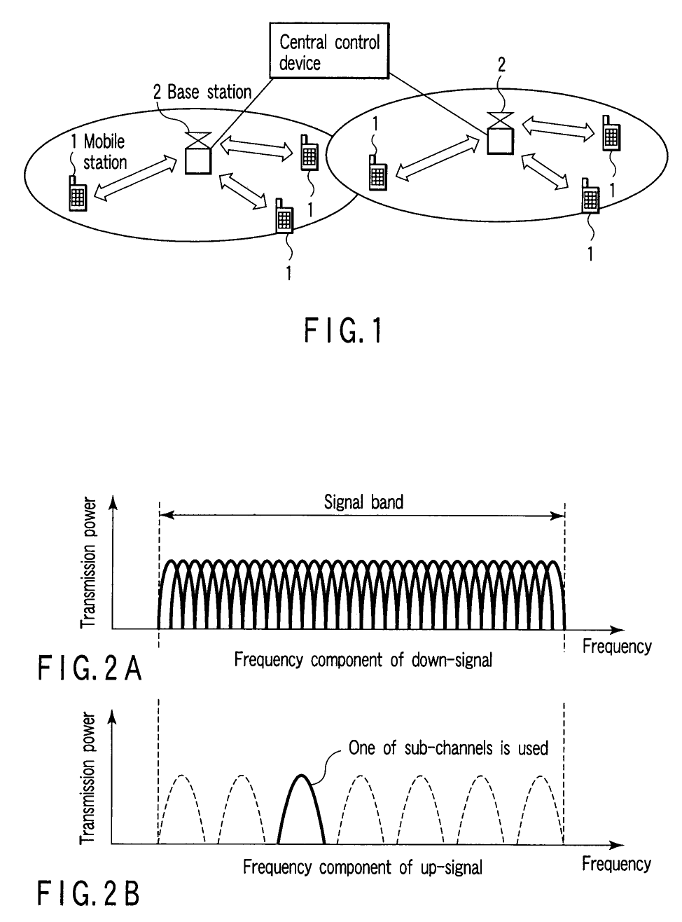

As shown in FIG. 1, radio communication is performed between a certain radio base station (hereinafter referred to as “the base station 2”) and, in general, a plurality of radio communication apparatuses (hereinafter each referred to as “the mobile station 1”) located in the service area of the base station 2. The base station 2 is connected to another base station 2 via a central control device mainly using a cable. The central control device is connected to a network.

A signal, so-called down-signal, transmitted from the base station 2 to each mobile station 1 is of an orthogonal frequency division multiplexing (OFDM) scheme and comprises a plurality of sub-carriers, as is shown in FIG. 2A. In contrast, a signal, so-called up-signal, transmitted from each mobile station 1 to the base station 2 is of a frequency hopping (FH) scheme as shown in FIG. 2B, in which the same signal band as that of the down-signal is decomposed into a plurality of sub-channels, and these sub-channels are sequentially used.

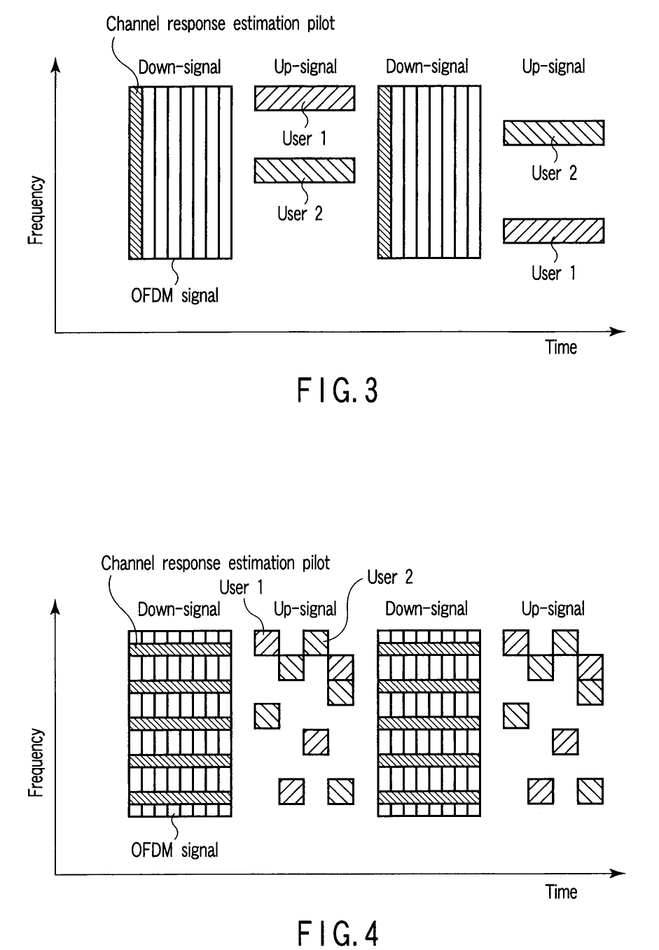

In a radio communication system according to each embodiment, up-signals and down-signals are multiplexed in a time-series manner. FIGS. 3 and 4 show examples of manners of multiplexing of up- and down-signals. As shown, up- and down-signals are alternately transmitted with time. The example of FIG. 3 is a low-rate FH scheme example, in which in each mobile station, a certain sub-channel is used in a certain period for up-signals, and is hopped to another sub-channel in the next period for up-signals. The example of FIG. 4 is a high-rate FH scheme example, in which in each mobile station, a plurality of sub-channels are hopped in a certain period for up-signals. In both FH schemes, two or more sub-channels may be used simultaneously.

The base station 2 may transmit data as a down-signal to a single mobile station or a plurality of mobile stations in a certain period for down-signals. The down-signal needs to include pilot signals sufficient at least for estimating the channel response values of the entire frequency band. Each of the sub-carriers may use an OFDM symbol as a pilot signal for channel response estimation, as is shown in FIG. 3. Alternatively, a plurality of pilot sub-carriers, each of which comprises a plurality of OFDM symbols, may be used as pilot signals for channel response estimation, as is shown in FIG. 4.

### FIRST EMBODIMENT

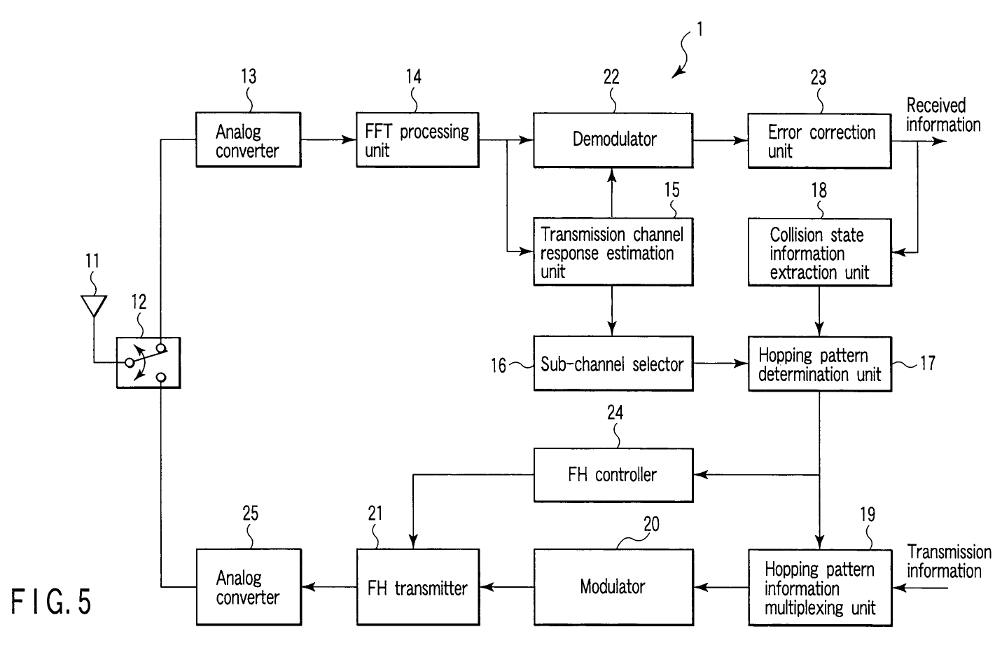

Referring to the block diagram of FIG. 5, a description will be given of a radio communication apparatus (mobile station 1) according to a first embodiment.

The mobile station 1 of this embodiment determines a frequency-hopping pattern from sub-channels of a good propagation environment based on a signal supplied from the base station 2, and performs transmission using the determined frequency-hopping pattern. The mobile station 1 comprises an OFDM receiver and HF transmitter. As shown in FIG. 5, the mobile station 1 comprises an antenna 11, antenna duplexer 12, analog converter 13, FFT (fast Fourier transform) processing unit 14, transmission channel response estimation unit 15, sub-channel selector 16, hopping pattern determination unit 17, collision state information extraction unit 18, hopping pattern information multiplexing unit 19, modulator 20, FH transmitter 21, demodulator 22, error correction unit 23, FH controller 24 and analog converter 25.

The antenna 11 receives an OFDM signal transmitted from the base station 2, and supplies it to the analog converter 13 via the antenna duplexer 12. The analog converter 13 converts the OFDM signal into a baseband signal and then to a digital signal. Subsequently, the FFT processing unit 14 performs fast Fourier transform (FFT) on the digitized received signal, thereby dividing it into sub-carriers. These sub-carriers are output to the demodulator 22.

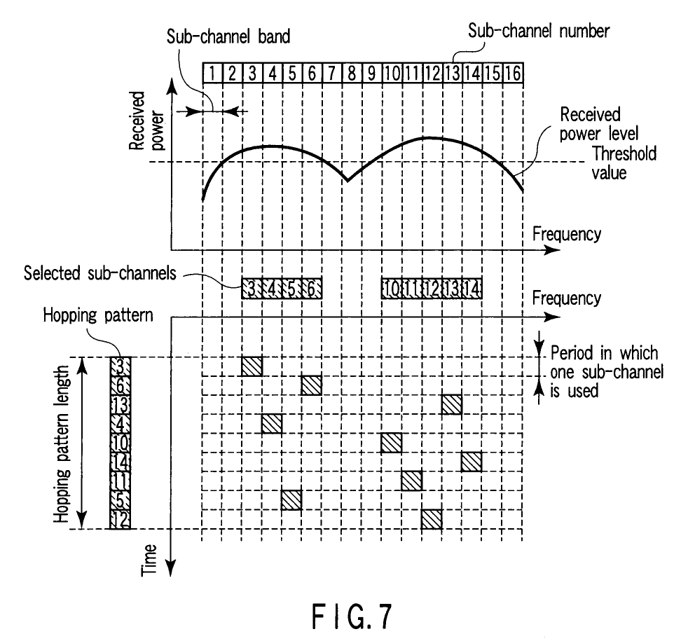

The FFT processing unit 14 extracts pilot signals from the signal subjected to FFT, and outputs the pilot signals to the transmission channel response estimation unit 15. The transmission channel response estimation unit 15 estimates the channel response values of all frequency bands based on the pilot signals. For example, when the transmission channel response estimation unit 15 estimates the channel response of a certain sub-carrier, it calculates the average of the received pilot symbol power levels of a plurality of sub-carriers near the certain sub-carrier. If a plurality of OFDM symbols are assigned as pilot signals, the received pilot signal power levels of the OFDM symbols of each sub-carrier are averaged, instead of averaging the pilot symbol received power levels of sub-carriers, thereby determining the channel response of the certain sub-carrier. Thus, by estimating the channel response based on the pilot signals formed of a plurality of sub-carriers or formed of a plurality of OFDM symbols, the estimated channel response is accurate almost free from the influence of, for example, noise. Referring later to FIG. 7, a description will be given of examples of channel response values.

The sub-channel selector 16 averages the estimated channel response values, i.e., power levels, in each sub-channel bandwidth, and selects sub-channels having a received power level not less than a predetermined value. The sub-channel selector 16 may detect noise power or interference power, as well as the received signal power, thereby selecting sub-channels having a signal-to-noise ratio or signal-to-interference ratio not less than a threshold value. Referring later to FIG. 7, a description will also be given of a case where sub-channels are selected based on the estimated channel response value.

On the other hand, the demodulator 22 uses the estimated channel response value output from the transmission channel response estimation unit 15, thereby acquiring an FFT-processed sub-carrier and performing synchronous wave detection. After that, the error correction unit 23 performs error correction on a predetermined number of sub-carriers subjected to synchronous wave detection, and acquires received information. The received information is output as an output of OFDM receiver. The received information includes user information and control information. The user information is provided for a user, and includes, for example, video, voice and character data. The control information includes collision state information. The collision state information indicates the result of determination as to whether there are sub-channels colliding with each other, by comparing the frequency-hopping patterns of all mobile stations 1 that are accessing the base station 2. Collision of sub-channels means that a plurality of mobile stations 1 simultaneously use the same sub-channel, i.e., the same frequency band. From the collision state information, each mobile station 1 can detect how to change its frequency-hopping pattern in order to avoid collision of sub-channels.

The hopping pattern determination unit 17 acquires sub-channel information indicating sub-channels selected by the sub-channel selector 16, and collision state information from the collision state information extraction unit 18, thereby determining a frequency-hopping pattern so that those of the sub-channels indicated by the sub-channel information, which are not colliding, are used.

The hopping pattern information multiplexing unit 19 receives transmission information and hopping pattern information indicating the frequency-hopping pattern determined by the hopping pattern determination unit 17, and multiplexes the transmission information and hopping pattern information. The modulator 20 modulates the resultant transmission information into information suitable for radio transmission. On the other hand, FH controller 24 designates sub-channels in units of hopping intervals, based on the determined frequency-hopping pattern, and informs the FH transmit-ter 21 of the designated sub-channels.

The FH transmitter 21 converts modulation signals from the modulator 20 into frequency signals corresponding to the sub-channels designated by the FH controller 24. The analog converter 25 converts the output signal of the FH transmitter 21 into a radio frequency signal, and this signal is transmitted from the antenna 11 to the base station 2 via the antenna duplexer 12.

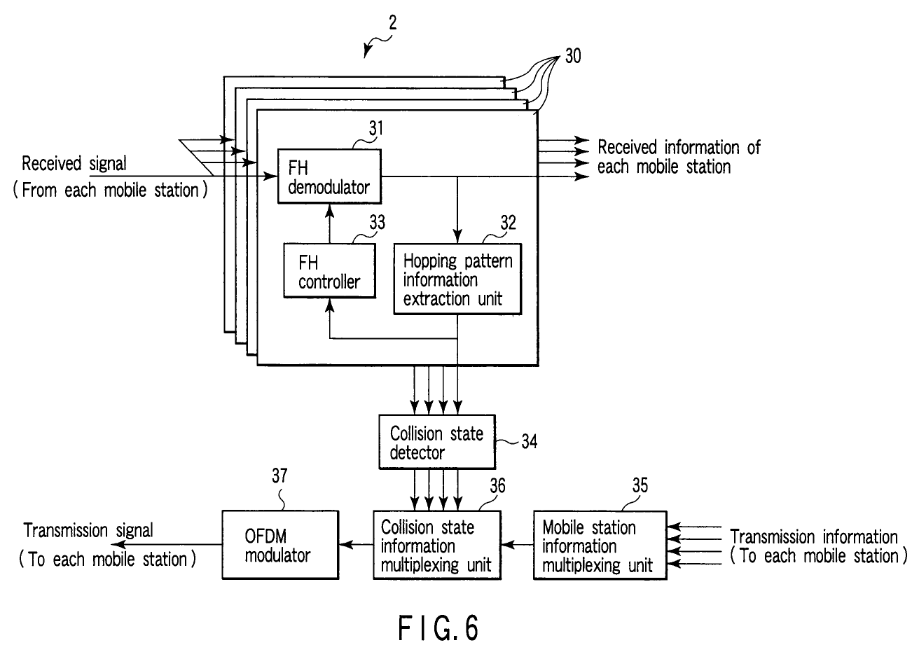

Referring now to FIG. 6, the radio base station 2 of the first embodiment will be described.

The base station 2 of the first embodiment receives FH signals from a plurality of mobile stations 1 belonging to the service area of the base station 2, extracts the frequency hopping pattern of each mobile station 1 from the signals, detects colliding sub-channels by comparing the extracted frequency hopping patterns, and informs each mobile station 1 of the colliding sub-channels. As shown in FIG. 6, the base station 2 comprises a plurality of receiving units 30 corresponding to the mobile stations 1, a collision state detector 34, mobile station information multiplexing unit 35, collision state information multiplexing unit 36 and OFDM modulator 37. Each receiving unit 30 includes an FH demodulator 31, hopping pattern information extraction unit 32 and FH controller 33.

Each receiving unit 30 is prepared for the corresponding mobile station 1, and arranged to receive a signal therefrom and extract the received information of the mobile station 1 from the received signal. The FH demodulator 31 demodulates the received signal to acquire the received information. The received information contains the frequency-hopping pattern of the corresponding mobile station 1. The hopping pattern information extraction unit 32 extracts hopping pattern information from the received information. The FH controller 33 receives the extracted hopping pattern information, determines, from this pattern, sub-channels to be demodulated by the FH demodulator 31, and controls the demodulator 31 to demodulate the sub-channels.

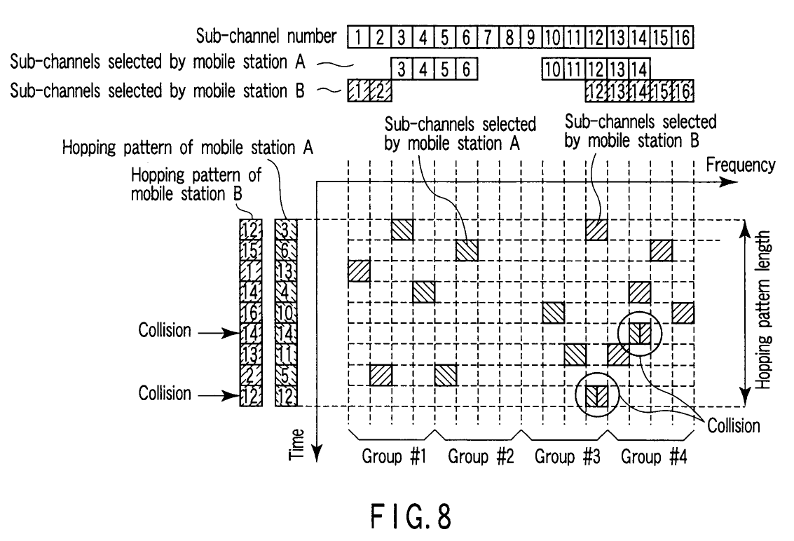

The collision state detector 34 receives hopping pattern information from the receiving units 30, compares the frequency-hopping patterns of all mobile stations 1 based on the received hopping pattern information, and detects whether colliding sub-channels exist. Thus, the collision state detector 34 detects which sub-channels in the frequency hopping patterns are colliding with each other, and outputs collision state information indicating the detection result. Referring later to FIG. 8, the manner of detecting collision of sub-channels by the collision state detector 34 will be described.

The mobile station information multiplexing unit 35 multiplexes transmission information to be sent to the mobile stations 1, while the collision state information multiplexing unit 36 multiplies the multiplex transmission information and collision state information. The OFDM modulator 37 converts the output signal of the collision state information multiplexing unit 36 into an OFDM signal, then converts it into a radio frequency signal, and transmits this signal to each mobile station 1 via an antenna (not shown). It is preferable that the base station 2 periodically provides each mobile station 1 with a signal containing collision state information.

Referring now to FIG. 7, a description will be given of a manner of estimating channel response values by the transmission channel response estimation unit 15 of the mobile station 1 shown in FIG. 5, and a manner of selecting sub-channels by the sub-channel selector 16 based on the estimated channel response values.

The transmission channel response estimation unit 15 estimates the channel response values indicated by the curved line shown in FIG. 7. Specifically, the curved line indicates the received signal power levels of a plurality of sub-channels designated by sub-channel numbers. That is, the curved line indicates received signal power levels (into which estimated channel response values are converted) corresponding to a certain frequency. Each received signal power level corresponds to an estimated channel response that indicates the amplitude and phase of the corresponding propagation path.

The sub-channel selector 16 selects sub-channels having power levels (which correspond to their estimated channel response values) higher than a predetermined value. In other words, the selector 16 sets a certain threshold value, and selects sub-channels having a power level higher than the threshold value. The selected sub-channels have a better propagation environment than non-selected ones. In the case of FIG. 7, the sub-channel selector 16 selects nine sub-channels with sub-channel numbers 3, 4, 5, 6, 10, 11, 12, 13 and 14. These nine sub-channels are arranged at random, thereby providing a provisional hopping pattern. In FIG. 7, a frequency-hopping pattern is selected in which the sub-channels are hopped in order of 3, 6, 13, 4, 10, 14, 11, 5 and 12.

Referring then to FIG. 8, a description will be given of collision of sub-channels detected by the collision state detector 34 of the base station 2. FIG. 8 shows a case where the base station 2 receives signals from mobile stations A and B, the hopping pattern information extraction unit 32 extracts hopping pattern information, and the collision state detector 34 detects colliding sub-channels.

The hopping pattern information extraction unit 32 of the receiving unit 30 that has received a signal from the mobile station A extracts, from this signal, sub-channel numbers 3, 6, 13, 4, 10, 14, 11, 5 and 12 as hopping pattern information. Further, the hopping pattern information extraction unit 32 of the receiving unit 30 that has received a signal from the mobile station B extracts, from this signal, sub-channel numbers 12, 15, 1, 14, 16, 14, 13, 2 and 12 as hopping pattern information. The collision state detector 34 compares these hopping pattern information items to detect that sub-channels with numbers 14 and 12 are colliding with each other. Although both mobile stations A and B use sub-channels with number 13, they do so at different times, therefore these sub-channels do not collide with each other.

The collision state information multiplexing unit 36 provides the mobile stations with collision state information indicating the collision state. To completely show the collision state, it is necessary to indicate the number of collisions at each period of use of each sub-channel. In this case, the amount of the collision state information is (the number of sub-channels×the number of periods of use×bits required to express the number of collisions). If 4 bits are used to express the number of collisions, the amount of the collision state information in the example of FIG. 8 is 576 bits (=16×9×4). This matrix information may be used as the collision information. However, to reduce the information amount, the following two expressions may be used instead of the matrix information, although the accuracy of information is reduced.

Firstly, the number of collisions of each sub-channel and the number of collisions in each period of use are calculated and informed. The required information amount is [(the number of sub-channels+the number of periods of use)×bits required to express the number of collisions]. In the example of FIG. 8, each of the sub-channels with numbers 12 and 14 collides one time, and the other sub-channels do not collide. Assuming that 4 bits are used to express the number of collisions and the number of sub-channels is 16, an information amount of 100 bits [=(16+9)×4] is required. Further, in this case, assume that the number of collisions larger than 15 is expressed as 15.

Secondly, the number of collisions in units of sub-channel groups each consisting of a predetermined number of adjacent sub-channels, and the number of collisions in each period of use is informed. To reduce the required collision information amount, this method utilizes that adjacent sub-channels exhibit a close channel response, therefore it is very possible that successive sub-channels are liable to be selected. The required information amount is [(the number of sub-channel groups+the number of periods of use)×bits required to express the number of collisions]. In the example of FIG. 8, 16 sub-channels are decomposed into four groups each consisting of four sub-channels. One collision occurs in sub-channel groups #3 and #4, while no collision occurs in sub-channel groups #1 and #2. Assuming that 4 bits are used to express the number of collisions and the number of sub-channel groups is 4, an information amount of 52 bits [=(4+9)×4] is required. Also in this case, assume that the number of collisions larger than 15 is expressed as 15.

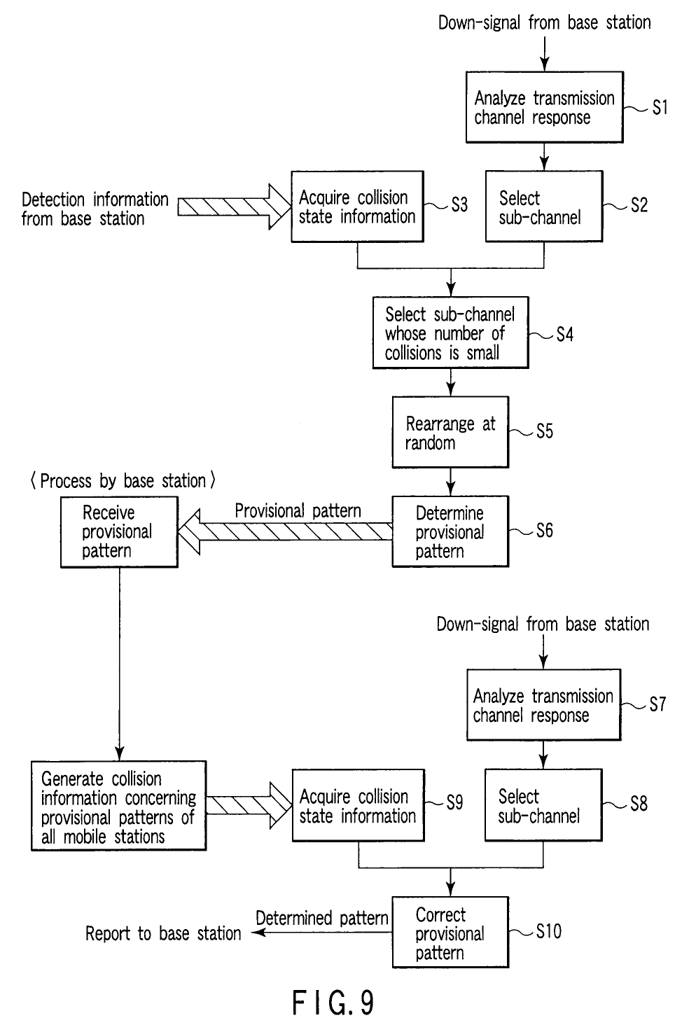

Referring to FIG. 9, a description will be given of the operation of the mobile station 1 performed to acquire collision state information from the base station 2, and change a provisional frequency-hopping pattern based on the acquired information, thereby acquiring a practical frequency-hopping pattern.

The mobile station 1 receives an OFDM signal from the base station 2 (down-signal), and estimates the channel response values of all received frequency bands (step S1), thereby acquiring sub-channels having a received power level higher than a threshold value (step S2). Further, the mobile station 1 extracts, from the base station 2, collision state information indicating the collision state of each sub-channel (step S3).

Subsequently, referring to the collision state information, the mobile station 1 selects a predetermined number of sub-channels from a plurality of sub-channels that exhibit a good channel response, in order beginning with a sub-channel of the least number of collisions (step S4), thereby rearranging the selected sub-channels at random to form a provisional hopping pattern (steps S5 and S6). The mobile station 1 multiplexes hopping pattern information indicating the provisional hopping pattern, using the hopping pattern information multiplexing unit 19, and transmits the resultant information to the base station 2.

Upon receiving the provisional frequency-hopping pattern from the mobile station 1, the base station 2 updates the collision state information and transmits the updated information to the mobile station 1.

The mobile station 1 again receives, as at the step S1, an OFDM signal from the base station 2 (down-signal) and estimates the channel response values of all received frequency bands (step S7), thereby acquiring sub-channels having a received power level higher than a threshold value (step S8). Almost simultaneously, the mobile station 1 acquires, from the base station 2, collision state information indicating the collision state of each sub-channel (step S9). This collision information is updated by the base station 2 using the provisional hopping pattern. Using this information, the mobile station 1 changes the provisional hopping pattern, and transmits, to the base station 2, the updated provisional hopping pattern as a frequency-hopping pattern to be used in the next cycle (step S10). The base station and mobile station use this frequency-hopping pattern in the next hopping cycle. The hopping pattern determination unit 17 performs the change of the frequency-hopping pattern in the following manner.

If certain sub-channels included in the sub-channels used in the provisional frequency-hopping pattern satisfy at least one of the conditions that the number of collisions is not less than a predetermined value, and that the number of sub-channels used in the same hopping period as the certain sub-channel is not less than a predetermined value, the certain sub-channels are selected as candidates for replacement. It is determined at random whether each of the candidate sub-channels should be replaced. Each sub-channel determined to be replaced is replaced with the one of the unused sub-channels that shows the best propagation state. The frequency-hopping pattern after the completion of the replacement is used in the next hopping cycle. This pattern is input to the FH controller 24 and also transmitted to the base station.

If the collision state information indicates the number of collisions of each sub-channel group, it is determined, instead of comparing the numbers of collisions of sub-channels, whether each sub-channel included in the provisional frequency-hopping pattern is included in a sub-channel group in which the number of collisions is not less than a predetermined value.

In the process of switching a sub-channel, in which a large number of collisions have occurred, over to a sub-channel in which a small number of collisions have occurred, concentration on a certain sub-channel, in which a small number of collisions have occurred, may well occur. This can be avoided by randomly switching sub-channels.

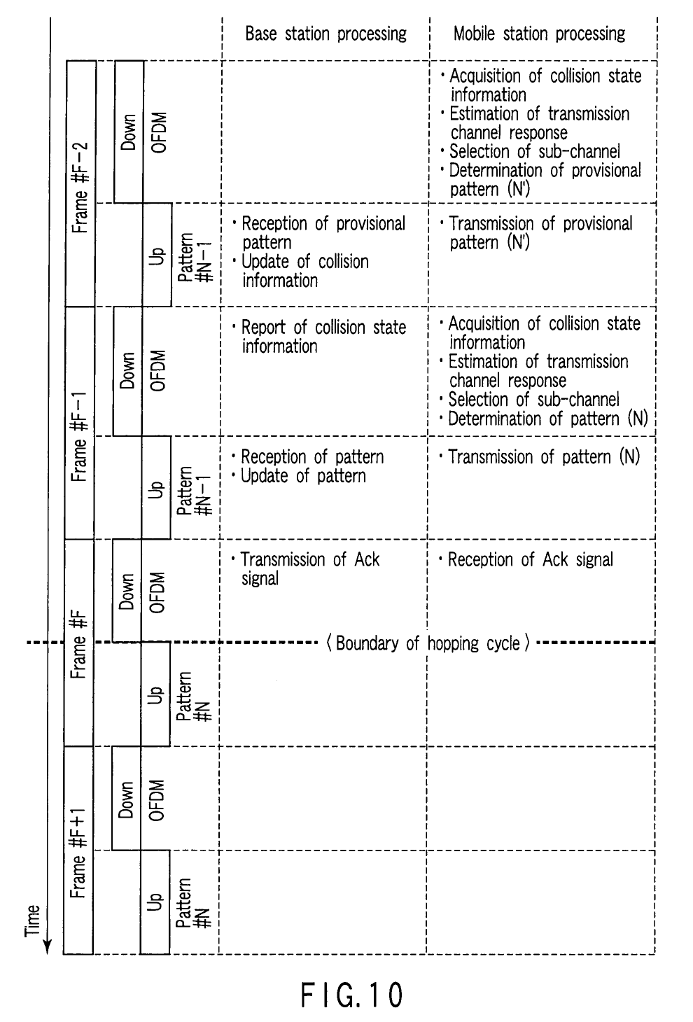

Referring to FIG. 10, a description will be given in a time-series manner of the operations of the mobile station 1 and base station 2 performed to update the frequency-hopping pattern. In FIG. 10, a combination of an up-signal and down-signal is defined as one frame for facilitating the explanation.

At frame #F-2 two frames before change of the frequency-hopping pattern, the mobile station 1 receives a signal from the base station 2, thereby performing channel response estimation and sub-channel selection to determine a provisional frequency-hopping pattern (N′) based on the previous collision state information. Using the up-signal of the same frame #F-2, the mobile station 1 informs the base station 2 of the determined provisional frequency-hopping pattern. Upon receiving this provisional frequency-hopping pattern, the base station 2 updates the collision state information.

Using the down-signal of frame #F-1, the base station 2 informs the mobile station 1 of the updated collision state information. Based on this collision state information, the mobile station 1 changes the frequency-hopping pattern and informs the base station 2 of the changed hopping pattern information, using the up-signal of frame #F-1. Upon receiving this information, the base station 2 updates the frequency-hopping pattern.

Upon receiving the frequency-hopping pattern, the base station 2 transmits an Ack signal to the mobile station 1, using the down-signal of frame #F. Thus, the base station informs the mobile station 1 that it has received the frequency-hopping pattern. Upon receiving the Ack signal from the base station 2 at the down-signal of frame #F, the mobile station 1 can start to perform FH-scheme communication with the base station 2 using the frequency-hopping pattern updated at frame #F. If the mobile station 1 fails to reliably transmit the frequency-hopping pattern at frame #F-1, it does not update the frequency-hopping pattern, and retransmit this frequency-hopping pattern to the base station 2 until it reaches there at or after frame #F.

As another method for transmitting hopping pattern information from the mobile station 1 to the base station 2, a frequency-hopping pattern only including data different from the previous data may be transmitted as difference information. This difference information comprises a sub-channel (or sub-channels) to be changed and its order in the frequency-hopping pattern. Thus, only data concerning a to-be-changed sub-channel (or sub-channels) is transmitted. If an upper limit is set to the number of sub-channels changeable, the transmission amount of hopping pattern information can be reduced.

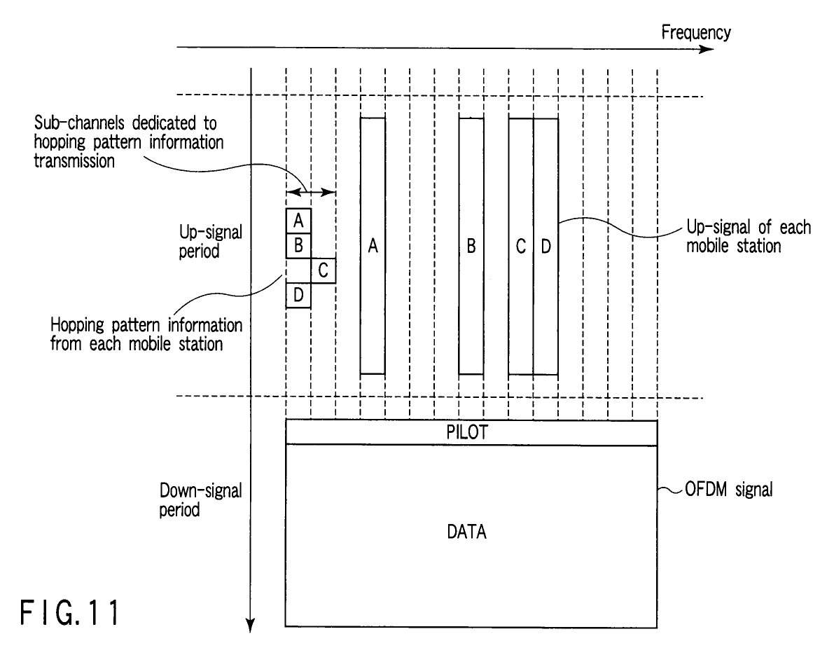

Referring to FIG. 11, the case of providing sub-channels dedicated to the transmission of hopping pattern information will be described.

In the above-described mobile station 1, hopping pattern information transmitted from the mobile station 1 to the base station 2 is sent to the hopping pattern information multiplexing unit 19, where multiplexing of the hopping pattern information and normal transmission information is performed. If the sub-channel used for transmission of the hopping pattern information has collided with another sub-channel, this information may not normally reach the base station 2. To avoid this, a group of sub-channels dedicated to transmission of frequency-hopping pattern information are prepared. To enable a plurality of mobile stations 1 to commonly use the sub-channel group, the period for up-signals is decomposed into a plurality of portions in each of which frequency-hopping pattern information can be transmitted. The base station 2 assigns the portions to the respective mobile stations, and each mobile station 1 can transmit frequency-hopping pattern information using the corresponding dedicated sub-channel group only during the assigned period.

In the above-described first embodiment, each mobile station determines, from a signal output from the base station, a frequency-hopping pattern concerning sub-channels of a good propagation environment, changes the frequency-hopping pattern based on collision state information output from the base station, and uses the changed pattern to perform FH-scheme transmission. Thus, utilizing the frequency-hopping multiplexing scheme, an appropriate communication state can be realized.

### SECOND EMBODIMENT

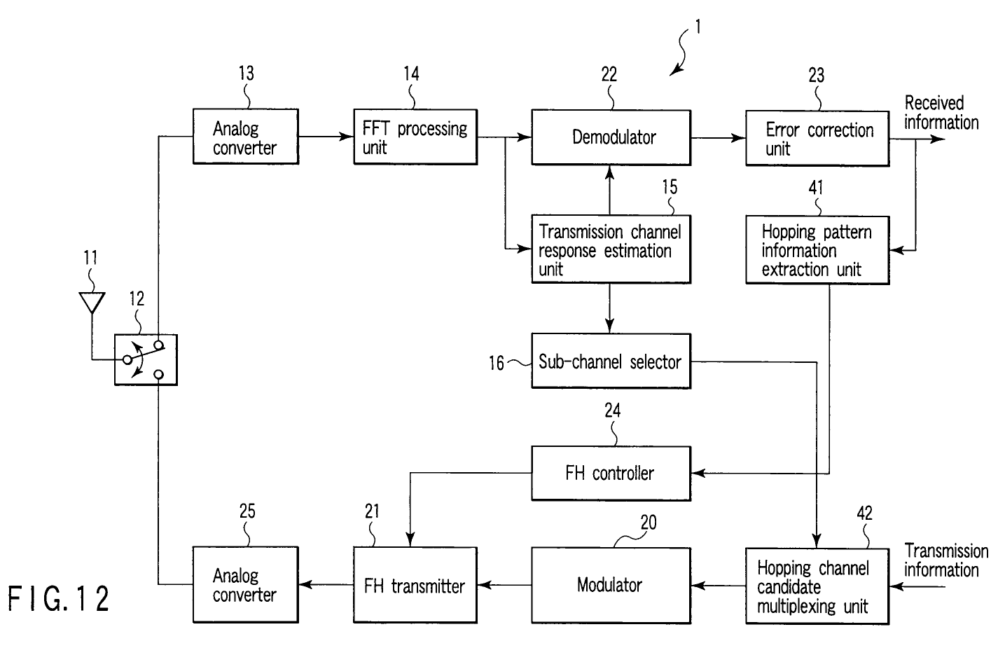

Referring now to FIG. 12, a description will be given of a radio communication apparatus (mobile station 1) according to a second embodiment of the invention.

The mobile station 1 of the second embodiment selects sub-channels of a good propagation environment based on a signal from the base station 2, and transmits the selected sub-channels to the base station 2. The base station 2 determines the respective frequency-hopping patterns of the mobile stations 1 based on sub-channels of a good propagation environment. Using the determined frequency-hopping patterns, the mobile stations 1 perform FH-scheme communication.

The mobile station 1 of the second embodiment differs from that of the first embodiment in that in the second embodiment, each mobile station 1 does not determine a frequency-hopping pattern, and performs FH-scheme communication based on hopping pattern information supplied from the base station 2. In the first and second embodiments, like reference numerals denote like elements, and duplication of explanation will be avoided. The mobile station 1 of the second embodiment employs a hopping pattern information extraction unit 41, instead of the collision state information extraction unit 18 and hopping pattern determination unit 17 incorporated in the first embodiment. Further, a hopping channel candidate multiplexing unit 42 is provided instead of the hopping pattern information multiplexing unit 19. The other structures of the mobile station 1 of the second embodiment are similar to those of the mobile station of the first embodiment.

The hopping pattern information extraction unit 41 extracts, from received information, hopping pattern information indicating a frequency-hopping pattern corresponding to the mobile station 1. As described above, received information includes user information and control information, and the control information includes hopping pattern information. The FH controller 24 designates sub-channels in units of hopping intervals, based on the frequency-hopping pattern acquired from the hopping pattern information extraction unit 41, and informs the FH transmitter 21 of the designated sub-channels.

The hopping channel candidate multiplexing unit 42 determines, as hopping channel candidates, sub-channels selected by the sub-channel selector 16, i.e., sub-channels having a received power level higher than a predetermined value, and multiplexes the candidate information and transmission information. The transmission information may include, as additional information, information indicating the received power level or propagation loss of each hopping channel candidate.

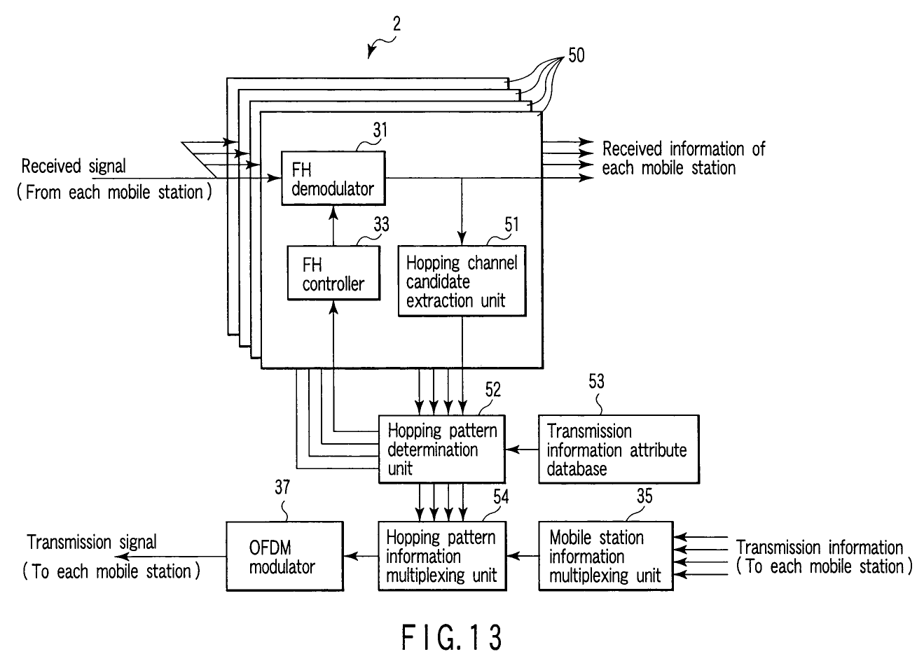

Referring then to FIG. 13, a radio base station (base station 2) according to the second embodiment will be described.

The base station 2 of the second embodiment receives FH signals from a plurality of mobile stations 1 belonging to the service area of the base station 2, and extracts hopping channel candidates for each mobile station 1 from the signals. Subsequently, the base station 2 compares the hopping channel candidates, determines the hopping patterns of the mobile stations 1 so that the sub-channels do not collide with each other, and informs each mobile station 1 of the corresponding hopping pattern information.

The base station 2 of the second embodiment differs from that of the first embodiment in that in the second embodiment, each mobile station 1 does not determine a frequency-hopping pattern, and performs FH-scheme communication based on hopping pattern information supplied from the base station 2. In the first and second embodiments, like reference numerals denote like elements, and duplication of explanation will be avoided. The base station 2 of the second embodiment employs a hopping channel candidate extraction unit 51 instead of the hopping pattern information extraction unit 32 of the first embodiment, and employs a hopping pattern determination unit 52 and transmission information attribute database 53 instead of the collision state detector 34 of the first embodiment. The base station 2 of the second embodiment further employs a hopping pattern information multiplexing unit 54 instead of the collision state information multiplexing unit 36. The other structures of the base station 2 of the second embodiment are similar to those of the base station of the first embodiment. Further, the receiving units 50 of the base station 2 of the second embodiment are prepared for the respective mobile stations 1 to receive signals therefrom. Each receiving unit 50 comprises the FH demodulator 31, hopping channel candidate extraction unit 51 and FH controller 33.

The hopping channel candidate extraction unit 51 extracts hopping channel candidate information from received information supplied from each mobile station 1 and demodulated by the FH demodulator 31, and sends the extracted information to the hopping pattern determination unit 52. The FH controller 33 determines sub-channels to be demodulated by the FH demodulator 31, using the frequency-hopping patterns determined for the respective mobile stations 1, and controls the demodulator 31 to demodulate the sub-channels.

The hopping pattern determination unit 52 extracts, from the transmission information attribute database 53, information indicating, for example, attributes required for an up-signal from each mobile station 1, and determines frequency-hopping patterns for mobile stations belonging to the service area of the base station 2, beginning with a frequency-hopping pattern for a mobile station of the top priority. The hopping pattern determination unit 52 determines the frequency-hopping patterns to avoid collision of sub-channels.

The transmission information attribute database 53 stores attributes of each mobile station 1, such as delay permissibility, transmission bit rate, up-signal error rate, and the average received power or propagation loss of hopping channel candidates. When the base station 2 determines the order of the mobile stations 1 to access, it refers to the data stored in the transmission information attribute database 53.

The hopping pattern information multiplexing unit 54 multiplexes the hopping pattern information determined by the hopping pattern determination unit 52, and the transmission information multiplexed by the mobile station information multiplexing unit 35. After that, the OFDM modulator 37 converts the output signal of the hopping pattern information multiplexing unit 54 into an OFDM signal and then into a radio frequency signal. The radio frequency signal is transmitted to each mobile station 1 via an antenna (not shown).

For determining the priority order of mobile stations based on information stored in the transmission information attribute database 53, a plurality of methods are possible and are varied depending on the manner of application of the methods. Some priority order determining methods will now be described. Realtime communication, such as audio communication or videophone communication, is of low delay permissibility. Therefore, for realizing realtime communication, it is necessary to minimize the delay time. When priority is imparted to realtime communication, if sub-channels of a good channel response condition are used, the received error rate can be reduced and signal delay due to retransmission be minimized. In this case, appropriate channels may not be used for non-realtime communication. However, since signal delay does not raise a serious problem in non-realtime communication, retransmission is performed to achieve a low received error rate.

To determine the priority order of realtime communications or that of non-realtime communications, priority is imparted to a communication in which the required transmission bit rate is high. In this case, since priority is imparted to a mobile station of a high transmission bit rate, communication of a large amount of data can be finished earlier. In a mobile station of a low transmission bit rate, the multi-value modulation number is switched from QAM to QPSK, or the redundancy of the error correction code is increased, to avoid an increase in error rate when a non-appropriate sub-channel is used. This enhances the entire transmission efficiency.

In addition to the above, when the received power levels or propagation losses of hopping channel candidates are transmitted as additional information from each mobile station 1, the error rate can be reduced by increasing the priority degree of a mobile station 1 of a high received power level or low propagation loss.

In the second embodiment, only sub-channel candidates used by each mobile station 1 are determined, and no temporal assignment is performed, which differs from the first embodiment. Accordingly, assuming that the curved line in FIG. 7 indicates the power level (i.e., estimated channel response) of each frequency band, it is determined that frequency bands that have a received power level higher than a preset threshold value indicated by the broken line are of a good propagation environment. In the example of FIGS. 7, 9 sub-channels are considered hopping channel candidates. If, for example, the number of all sub-channels is 16, hopping channel information is arranged in a 16-bit column, whereby “0” or “1” in each bit column indicates whether the sub-channel is a candidate. If the transmission rate allows, priority information may be added to hopping channel candidate information. Further, the average received power or propagation loss of selected sub-channels may be added as additional information.

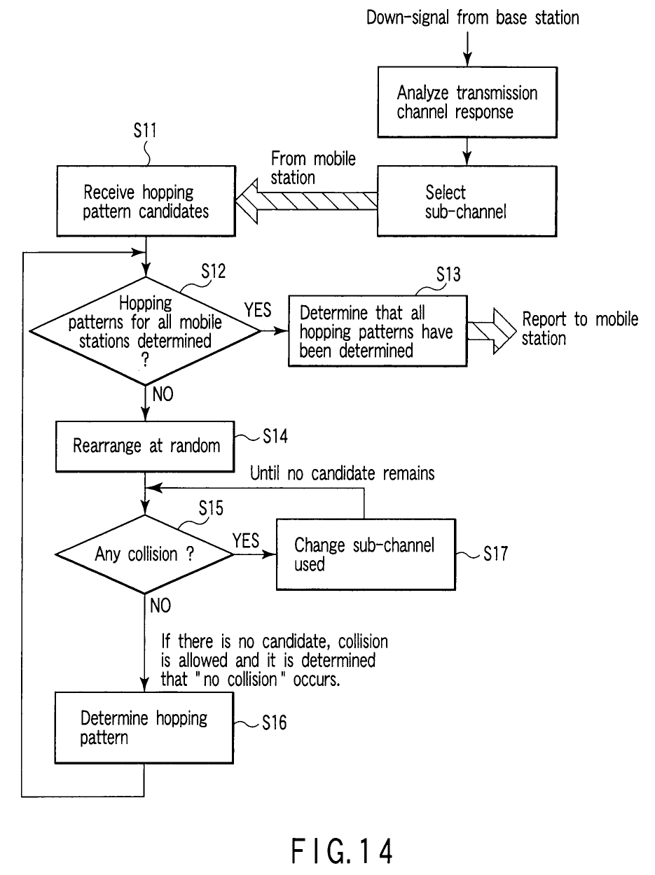

Referring to the flowchart of FIG. 14, a description will be given of the process of transmitting sub-channels of a good propagation environment selected by channel response analysis from the mobile stations 1 to the base station 2, and determining frequency-hopping patterns for the mobile stations 1 by the base station 1 so that no collision occurs between the sub-channels.

Each mobile station 1 receives an OFDM signal from the base station 2, acquires the estimated channel response values of all received frequency bands, and selects sub-channels having a received power level higher than a threshold value. The base station 2 receives, from each mobile station 1, the selected sub-channels of a relatively good propagation environment (step S11). Subsequently, the base station 2 detects whether frequency-hopping patterns for all mobile stations 1 are determined (step S12). The base station 2 grasps all data items concerning the mobile stations connected thereto, and is arranged to sequentially determine frequency-hopping patterns for the mobile stations. Accordingly, the base station 2 can detect whether frequency-hopping patterns for all mobile stations have been determined. If it is detected that frequency-hopping patterns for all mobile stations have been determined, the program proceeds to step S13, whereas if frequency-hopping patterns for all mobile stations have not yet been determined, the program proceeds to step S14. At step S13, the frequency-hopping determination process is finished.

At step S14, sub-channels are rearranged at random for each mobile station 1 to determine a frequency-hopping pattern. At this time, frequency-hopping patterns are determined beginning with that for mobile station A of the highest priority. More specifically, a predetermined number of sub-channels are selected from the hopping channel candidates reported by mobile station A of the highest priority, and are arranged at random. The resultant frequency-hopping pattern is used as that for mobile station A. Similarly, a frequency-hopping pattern is determined for mobile station B of the nest highest priority. Each time a frequency-hopping pattern is determined, it is determined whether colliding sub-channels exist between the frequency-hopping pattern and the frequency-hopping patterns previously determined for the mobile stations of higher priority degrees (step S15). The base station 2 grasps already assigned sub-channels and the order of use of the sub-channels, and stores them in a table. At step S15, the base station 2 compares the sub-channels and their order of use provisionally determined at step S14 with the contents of the table, thereby determining whether colliding sub-channels exist.

If there are colliding sub-channels, they are replaced with not yet used hopping channel candidates (step S17). For example, assume that when a frequency-hopping pattern is determined for mobile station B, a sub-channel included in the frequency-hopping pattern of mobile station A collides with a sub-channel included in that for mobile station B. The colliding sub-channel included in the frequency-hopping pattern for mobile station B is replaced with one of the not yet used hopping channel candidates of mobile station B. Then, the program returned to step S15. If collision occurs again even after the colliding sub-channel is replaced with any one of the candidates, the colliding sub-channel is replaced with one of the originally selected sub-channels. In this case, the same sub-channel is used twice.

If it is determined that there are no colliding sub-channels, the frequency-hopping pattern provisionally determined at step S14 is determined formally, and the program returns to step S12. The determination as to whether there are colliding sub-channels, performed at step S15, is made on all frequency-hopping patterns determined so far. Further, priority information is added to hopping channel candidate information, a predetermined number of sub-channels are selected, beginning with a sub-channel of the highest priority.

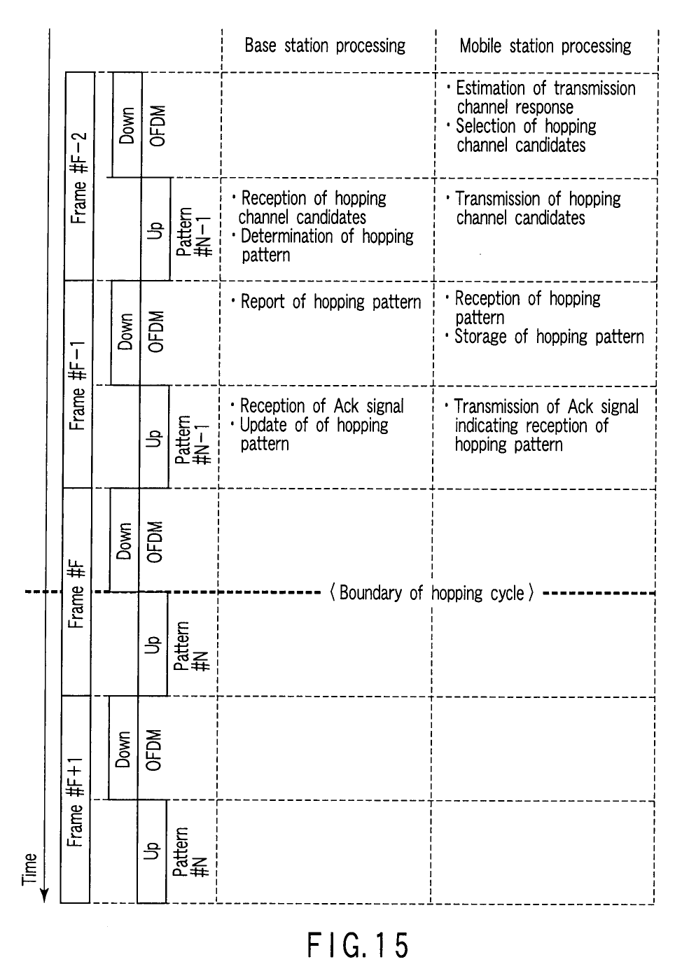

Referring to FIG. 15, a description will be given in a time-series manner of the operations of the mobile station 1 and base station 2 performed to update the frequency-hopping pattern. In FIG. 15, a combination of an up-signal and down-signal is defined as one frame for facilitating the explanation.

At frame #F-2 two frames before change of the frequency-hopping pattern, the mobile station 1 receives a signal from the base station 2, thereby performing channel response estimation and hopping channel candidate selection. Using the up-signal of the same frame #F-2, the mobile station 1 informs the base station 2 of hopping channel candidate information. The base station 2 determines a frequency-hopping pattern from the hopping channel candidate information, and informs the mobile station 1 of the frequency-hopping pattern using the down-signal of frame #F-1. The mobile station 1 receives and stores the frequency-hopping pattern, and informs the base station 2, using the up-signal of frame #F-1, of the fact that the frequency-hopping pattern has been normally received. Upon receiving this signal, the base station 2 updates the frequency-hopping pattern corresponding to the mobile station 1. The mobile station 1 continues transmission at the next frame #F, using the determined frequency-hopping pattern.

If the hopping channel candidate information does not normally reach the base station 2 at frame #F-2, the base station 2 transmits a request for retransmission of the information to the mobile station 1 at frame #F-1, and the mobile station again transmits the hopping channel candidate information to the base station. Further, if the frequency-hopping pattern information does not normally reach the mobile station at frame #F-1, the base station retransmits the same frequency-hopping pattern information, without changing the pattern information, until the mobile station normally receives the pattern information.

In the above-described second embodiment, the mobile station 1 selects sub-channels of a good propagation environment based on a signal from the base station 2, and transmits these sub-channels to the base station 2. The base station 2 determines a frequency-hopping pattern for the mobile station based on the selected sub-channels. Using the frequency-hopping pattern, each mobile station 1 can perform FH-scheme transmission. Thus, an appropriate communication state can be realized by frequency-hopping multiplexing.

### THIRD EMBODIMENT

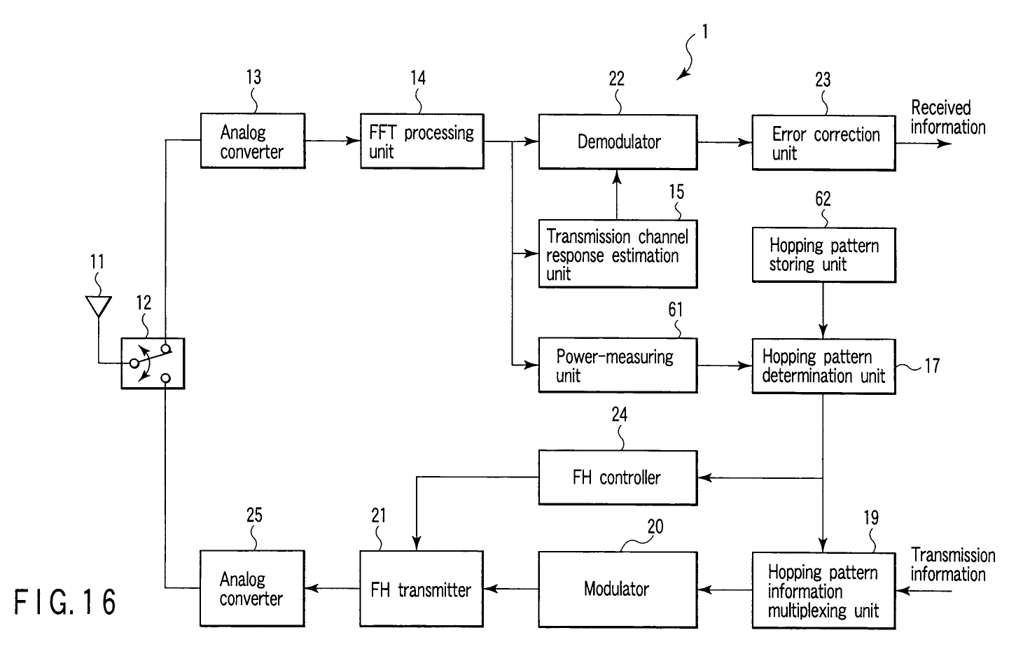

Referring to FIG. 16, a radio communication apparatus (mobile station 1) according to a third embodiment will be described.

The mobile station 1 according to the third embodiment detects a frequency-hopping pattern used by another mobile station 1, thereby determining a frequency-hopping pattern formed of sub-channels that are not incorporated in the detected frequency-hopping pattern.

The third embodiment differs from the first embodiment wherein the base station detects the collision state of frequency-hopping patterns. That is, in the third embodiment, each mobile station 1 detects the frequency-hopping pattern of another mobile station 1, thereby finding out unused sub-channels and incorporating the unused sub-channels in a frequency-hopping pattern. In the first and third embodiments, like reference numerals denote like elements, and duplication of explanation will be avoided. The mobile station 1 of the third embodiment employs a power-measuring unit 61 instead of the sub-channel selector 16, and employs a hopping pattern storing unit 62 instead of the collision state information extraction unit 18. The other structures of the mobile station 1 of the third embodiment are similar to those of the mobile station of the first embodiment shown in FIG. 5.

The power-measuring unit 61 measures the received signal characteristic of each sub-carrier based on digital data supplied from the FFT processing unit 14. The received signal characteristic of each sub-carrier is preferably received signal power, but is not limited to this. Based on the input received signal characteristic of each sub-carrier, the power-measuring unit 61 detects a frequency-hopping pattern used by another mobile station.

The hopping pattern storing unit 62 stores a plurality of predetermined frequency-hopping patterns corresponding to the base station 2 or radio communication system that manages the service area to which the mobile station 1 belongs.

Referring to the frequency-hopping patterns stored in the hopping pattern storing unit 62 and the sub-carriers having their received signal power measured by the power-measuring unit 61, the hopping pattern determination unit 17 determines which ones of the frequency-hopping patterns stored in the unit 62 are now used. After that, the unit 17 selects one of the unused frequency-hopping patterns, and uses this pattern for the mobile station 1. Thus, the mobile station 1 detects the frequency-hopping pattern used by another mobile station based on the input received signal characteristic of each sub-carrier, thereby selecting a frequency-hopping pattern other than the detected one.

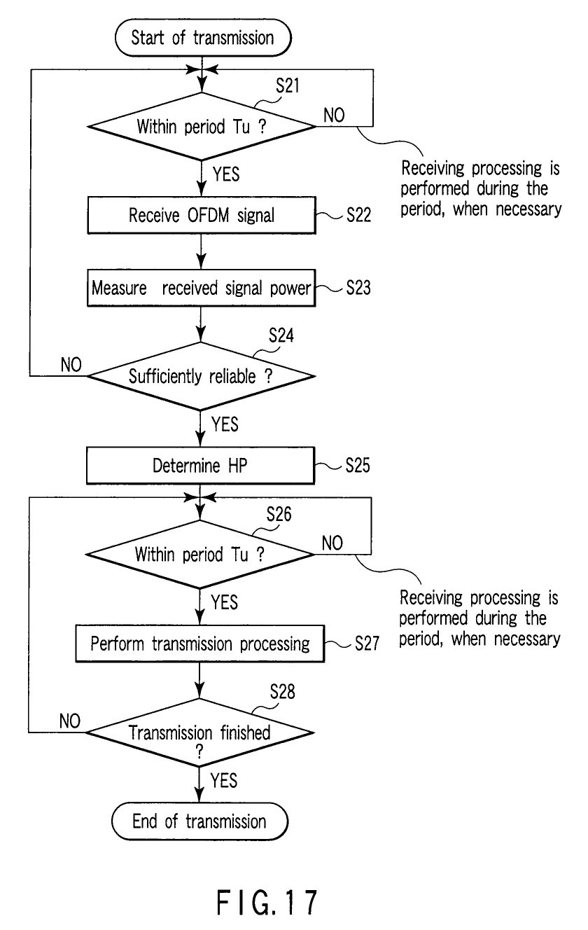

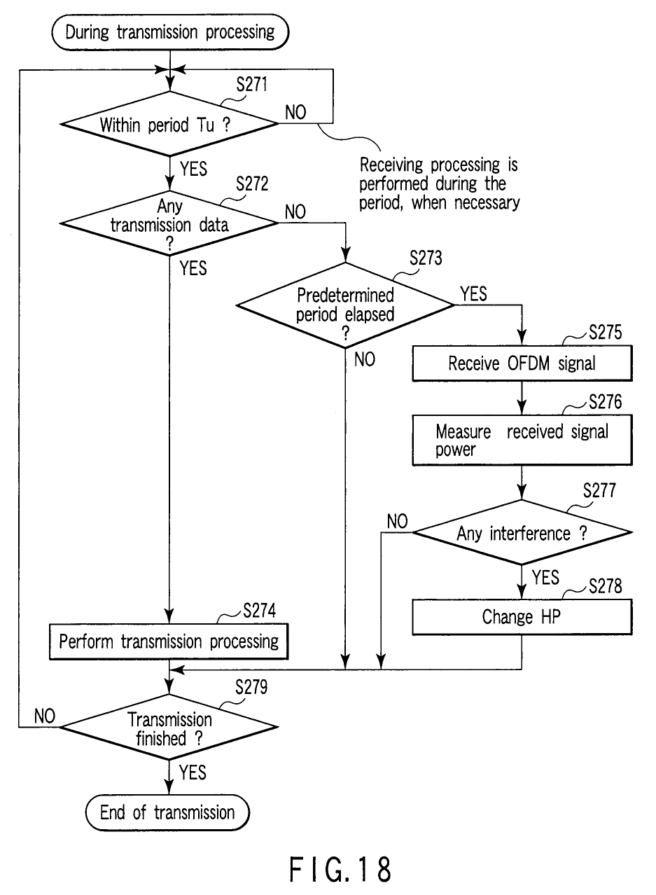

Referring to the flowcharts of FIGS. 17 and 18, a description will be given of the operation of the mobile station 1 from the start of transmission to the end of transmission. Assume here that the term in which the base station 2 can transmit a signal to the mobile station 1 is Td, and the term in which the mobile station 1 can transmit a signal to the base station 2 is Tu. The time required for a shift from the transmission period of the base station 2 to that of the mobile station 1, or vice versa, is set as a guard time. Tu and Td may be different from each other, and be dynamically changed.

Before starting transmission, the mobile station 1 confirms whether the time of start of transmission falls within the transmission enabled term Tu (step S21). If the time of start of transmission does not fall within the term Tu, the program returns to step S21 where the mobile station 1 waits for the term Tu to be reached. If, on the other hand, the start time falls within the term Tu, the program proceeds to step S22. If it is determined that the start time falls within the term Tu, the mobile station 1 operates the OFDM receiving function portions of the antenna duplexer 12 analog converter 13, FFT processing unit 14, power-measuring unit 61, etc., thereby receiving a radio signal transmitted from another mobile station (step S22).

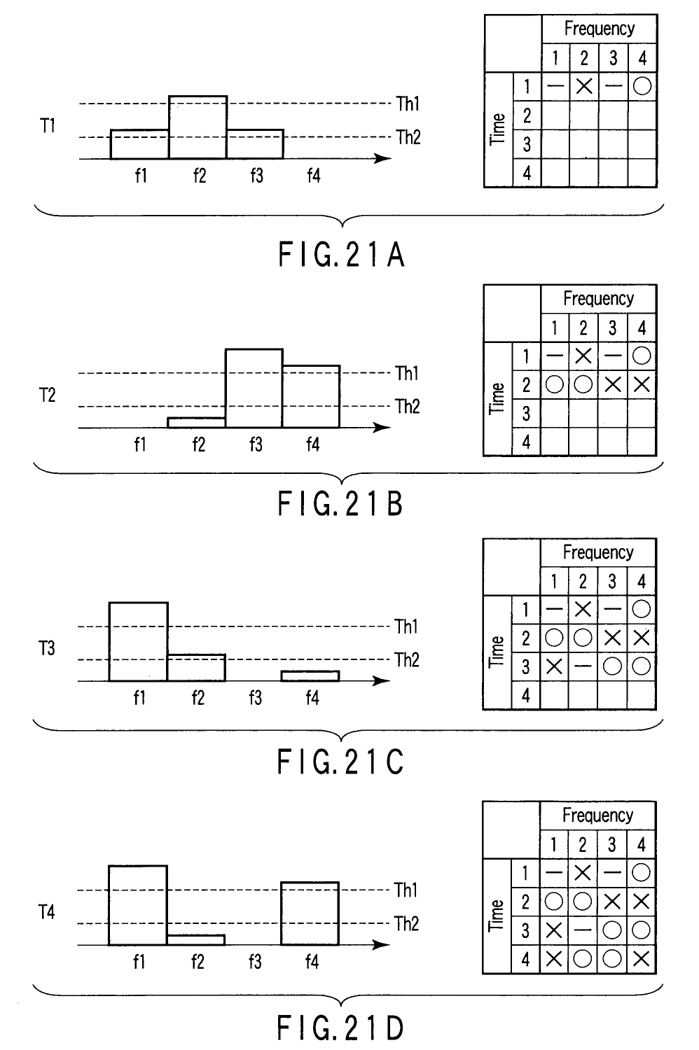

The power-measuring unit 61 measures the receiving characteristic of each sub-carrier from the digital data of each sub-carrier (step S23). It is determined whether each sub-channel is sufficiently reliable, from the receiving characteristic measured by the power-measuring unit 61 (step S24). If each sub-channel is sufficiently reliable, the program proceeds to step S25, whereas if it is not sufficiently reliable, the program returns to step S21. Thus, until the power-measuring unit 61 acquires a sufficiently reliable receiving characteristic, it repeatedly measures the receiving characteristic of each sub-channel within the term Tu. The receiving characteristic is measured from, for example, the receiving signal power of each sub-channel. As will be described later with reference to FIG. 21, when the receiving signal power of a sub-channel is sequentially measured N times (N is a natural number), if it is always lower than a certain threshold value, the sub-channel is determined not to be sufficiently reliable.

After that, the hopping pattern determination unit 17 selects the one of the frequency-hopping patterns stored in the hopping pattern storing unit 62 that is not used by any other mobile station 1, and determines it as a to-be-used frequency-hopping pattern (step S25). Subsequently, the mobile station 1 again confirms whether the time of start of transmission falls within the transmission enabled term Tu (step S26). If the start time does not fall within the term Tu, the program returns to the step S26, where the mobile station 1 waits for the term Tu to be reached. If the start time falls within the term Tu, the program proceeds to step S27, where transmission processing is started using the frequency-hopping pattern determined at step S25. At the next step S28, it is determined whether transmission processing has finished. If transmission processing has not yet finished, the program returns to step S26, whereas if transmission processing has finished, the transmission operation is finished.

As described above, the mobile station 1 detects a frequency-hopping pattern used by another mobile station 1, and selects a frequency-hopping pattern other than the detected one, with the result that interference between the mobile station 1 and said another mobile station is avoided.

Referring now to the flowchart of FIG. 18, the transmission process of the mobile station 1 at step S27 will be described in more detail.

Firstly, before starting transmission, the mobile station 1 confirms whether the time of start of transmission falls within the transmission enabled term Tu (step S271 corresponding to step S26 in FIG. 17). If the start time does not fall within the term Tu, the program returns to the step S271, where the mobile station 1 waits for the term Tu to be reached. If the start time falls within the term Tu, the program proceeds to step S272, where there is transmission data. If there is transmission data, the program proceeds to step S274, whereas if there is no trans-mission data, the program proceeds to step S273. At step S274, transmission data is transmitted to the base station 2 using the frequency-hopping pattern determined at step S25. At step S273, it is determined whether a predetermined period has elapsed. If the period has elapsed, the program proceeds to step S275, whereas if the period has not yet elapsed, the program proceeds to step S279. At step S279 (corresponding to step S28 in FIG. 17), it is determined whether transmission processing has finished. If transmission processing has not yet finished, the program returns to step S271, whereas if it has finished, the transmission operation is finished.

On the other hand, at step S275, the OFDM receiving function portions of the antenna duplexer 12 analog converter 13, FFT processing unit 14, power-measuring unit 61, etc., thereby receiving a radio signal transmitted from another mobile station. The power-measuring unit 61 measures the receiving characteristic of each sub-carrier from the digital data of each sub-carrier (step S276). At this time, until the power-measuring unit 61 acquires a sufficiently reliable receiving characteristic, it repeatedly measures the receiving characteristic of each sub-channel within the term Tu, as at step S24 in FIG. 17. It is determined at step S277 whether each sub-channel of the frequency-hopping pattern determined at step S25 is used by another mobile station 1. In other words, it is determined whether there is another mobile station 1 that interferes the frequency-hopping pattern determined at step S25. If interference exists, the program proceeds to step S278, whereas if no interference exists, the program proceeds to step S279. At step S278, the frequency-hopping pattern determined at step S25 is replaced with a frequency-hopping pattern that is not used by said another mobile station 1, referring to the hopping pattern storing unit 62.

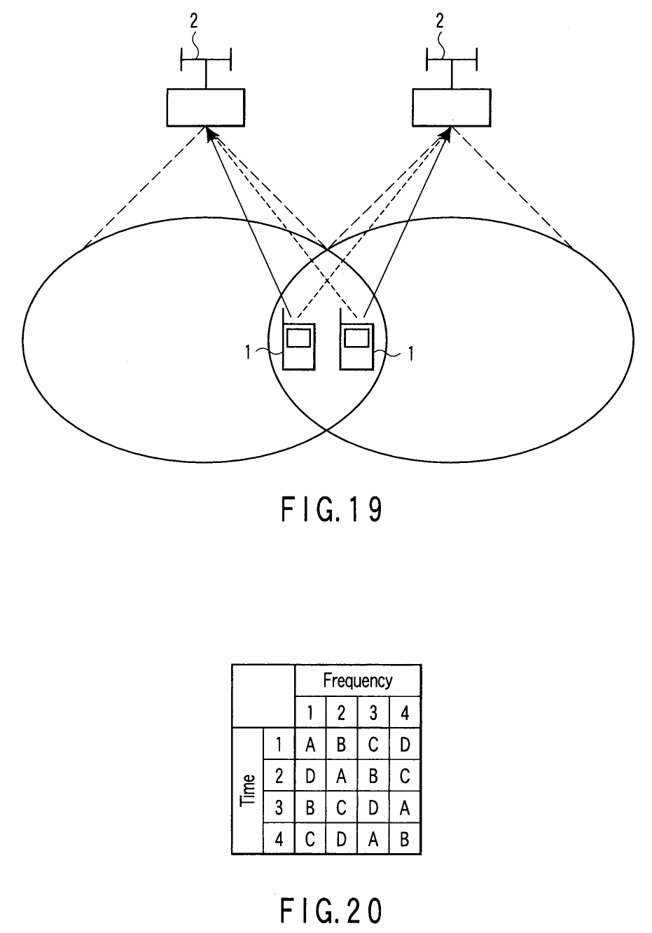

As described above, the mobile station 1 detects a frequency-hopping pattern used by another mobile station, and selects a frequency-hopping pattern other than the detected one, thereby avoiding interference with said another mobile station. The operation example shown in FIG. 18 is suitable for the case as shown in FIG. 19 where the radio communication system of the embodiment is used as a cellular system, and the same frequency is used by adjacent base stations. Specifically, interference between mobile stations belonging to different base stations 2, i.e., interference between adjacent cells, can be avoided by detecting, during transmission processing, a frequency-hopping pattern included in a radio signal transmitted from another mobile station 1.

Referring to FIGS. 20 and 21A to 21D, an operation example of the hopping pattern determination unit 17 performed to determine a frequency-hopping pattern will be described. FIG. 20 shows a frequency-hopping pattern example used in the radio communication system of the third embodiment. For facilitating the explanation, in the frequency-hopping pattern example, the number of hopping carriers is set to 4, and the hopping cycle is set to 4. The frequency-hopping pattern shown in FIG. 20 is stored in the hopping pattern storing unit 62.

In the example of FIG. 20, in frequency-hopping pattern A, sub-carriers 1, 2, 4 and 3 are assigned at times 1, 2, 3 and 4, respectively. FIG. 20 further shows frequency-hopping patterns B, C and D.

FIGS. 21A to 21D show examples of power measurement results of the power-measuring unit 61 of the mobile station 1 in the frequency-hopping pattern examples shown in FIG. 20. For the power measurement results, two determination threshold values Th1 and Th2 (Th1>Th2) are used. In this case, if the receiving power of a certain sub-carrier exceeds determination threshold value Th1, it is determined that another mobile station is using a frequency-hopping pattern in which this sub-carrier is assigned at this time. On the other hand, if the receiving power of a certain sub-carrier is less than determination threshold value Th2, it is determined that no mobile station is using a frequency-hopping pattern in which this sub-carrier is assigned at this time. The number of threshold values is not limited to 2, but may be set to three or more. Alternatively, only one threshold value may be used. However, a more accurate determination can be realized as the number of threshold values is increased.

At time 1 (T1) in FIG. 21A, it is determined that the receiving power of sub-carrier 2 (f2) exceeds determination threshold value Th1, and that of sub-carrier 4 (f4) is less than determination threshold value Th2. At time 2 (T2) in FIG. 21B, it is determined that the receiving power levels of sub-carriers 3 (f3) and 4 (f4) exceed determination threshold value Th1, and those of sub-carriers 1 (f1) and 2 (f2) are less than determination threshold value Th2. Similarly, at time 3 (T3) in FIG. 21C, it is determined that the receiving power level of sub-carrier 1 (f1) exceeds determination threshold value Th1, and those of sub-carriers 3 (f3) and 4 (f4) are less than determination threshold value Th2. At time 4 (T4) in FIG. 21D, it is determined that the receiving power levels of sub-carriers 1 (f1) and 4 (f4) exceed determination threshold value Th1, and those of sub-carriers 2 (f2) and 3 (f3) are less than determination threshold value Th2.

If the power measurement results shown in FIGS. 21A to 21D are acquired at step S23 in FIG. 17, it is mainly aimed, using the power measurement results, to detect a frequency-hopping pattern that is not used by any other mobile station. In this case, it is desirable to pay attention to the results determined to be less than determination threshold value Th2. In the examples of FIGS. 21A to 21D, it can be understood, from the table of FIG. 20 stored in the hopping pattern storing unit 62, that in the hopping cycle, the sub-carrier receiving power levels of frequency-hopping patterns A, B, C and D are less than determination threshold value Th2 three times, no time, no time and four times, respectively. From these results, it can be understood that the mobile station 1 should select frequency-hopping pattern D. Furthermore, the mobile station 1 may be set such that if the sub-carrier receiving power of a certain frequency-hopping pattern is less than determination threshold value Th2 sequentially N times, the mobile station 1 considers that the determination result is sufficiently reliable in selecting a suitable frequency-hopping pattern, and hence selects this pattern immediately. In the examples of FIGS. 21A to 21D, assume that N=2. The sub-carrier receiving power level of frequency-hopping pattern D is less than threshold value Th2 continuously at times T1 and T2, which means that frequency-hopping pattern D satisfies the condition N=2. Accordingly, the mobile station should select frequency-hopping pattern D.

If the power measurement results shown in FIGS. 21A to 21D are acquired at step S276 in FIG. 18, it is mainly aimed to detect, from the measurement results, whether the frequency-hopping pattern used by the mobile station 1 is also used by another mobile station 1. In this case, it is desirable to pay attention to the results determined to exceed determination threshold value Th1. In the examples of FIGS. 21A to 21D, in the hopping cycle, the sub-carrier receiving power levels of frequency-hopping patterns A, D, B and C exceed determination threshold value Th1 no time, no time, four times and two times, respectively. From these results, it can be understood that if the mobile station 1 uses at this time frequency-hopping pattern B or C, the frequency-hopping pattern contains interference. Further, the mobile station 1 may be set such that if the sub-carrier receiving power of a certain frequency-hopping pattern exceeds determination threshold value Th1 sequentially N times, the mobile station 1 considers that the determination result is sufficiently reliable in determining existence of interference, and hence immediately determines that the frequency-hopping pattern contains interference. In the examples of FIGS. 21A to 21D, assume that N=2. The sub-carrier receiving power level of frequency-hopping pattern B exceeds threshold value Th1 continuously at times T1 and T2, which means that frequency-hopping pattern B satisfies the condition N=2. Accordingly, the mobile station 1 determines that frequency-hopping pattern B contains interference. If it is thus determined that interference exists, it is desirable to select a new frequency-hopping pattern using the above-mentioned method of paying attention to the power measurement results less than Th2.

As described above, in the third embodiment, a frequency-hopping pattern used by another mobile station 1 is detected, and a frequency-hopping pattern other than the detected one is selected. As a result, occurrence of interference can be suppressed and an appropriate communication state can be realized, using the frequency-hopping multiplexing scheme. Furthermore, the radio communication system of the third embodiment can realize the above-described control by only one-time receiving processing, which means that the above-described advantage can be acquired by an extremely simple structure and operation.

### FOURTH EMBODIMENT

In the third embodiment, each mobile station detects a frequency-hopping pattern used by another mobile station, and selects a frequency-hopping pattern other than the detected one. In contrast, in a radio communication system according to a fourth embodiment, power levels measured by each mobile station are sent to the base station, and the base station determines, from the measurement results, the frequency-hopping pattern of each mobile station, and supplies the pattern thereto.

The mobile station 1 according to the fourth embodiment does not need the hopping pattern determination unit 17 and hopping pattern storing unit 62 shown in FIG. 16. Further, the hopping pattern information multiplexing unit 19 does not multiplex frequency-hopping pattern information and transmission information, but multiplexes the power levels measured by the mobile station 1 and transmission information, and the FH transmitter 21 transmits a signal indicating the multiplexed information to the base station. The other structures of the mobile station 1 are similar to those of the mobile station 1 of the third embodiment.

In the fourth embodiment, the base station 2 comprises the hopping pattern determination unit 17 and hopping pattern storing unit 62. Upon receiving power measurement results from each mobile station 1, the base station 2 determines a frequency-hopping pattern for each mobile station using the hopping pattern determination unit 17, referring to the hopping pattern storing unit 62.

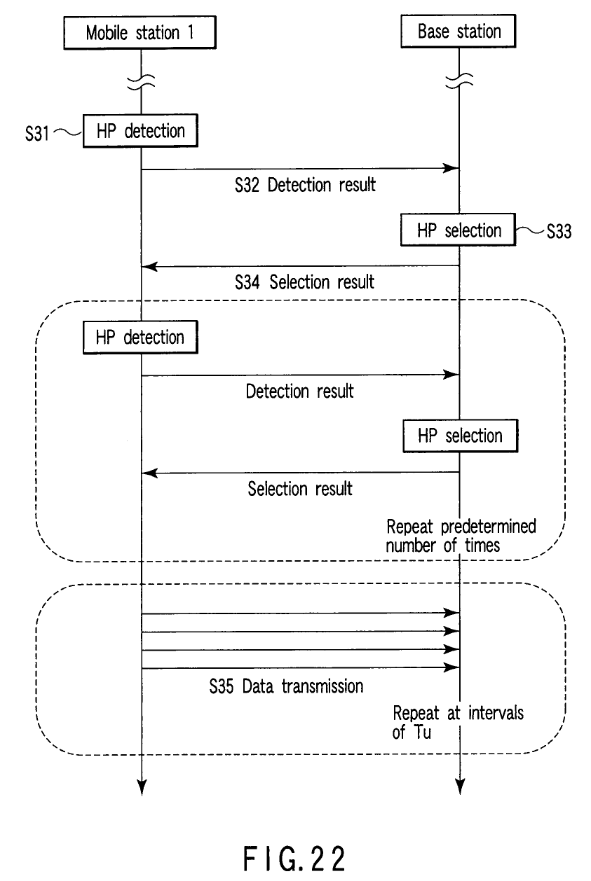

Referring to the sequence diagram of FIG. 22, the operations of the mobile station 1 and base station 2 will be described.

Firstly, at the start of transmission or during transmission, the mobile station 1 detects the frequency-hopping pattern of another mobile station (step S31), and informs the base station 2 of the detection result (step S32). The contents of the information include, for example, the measured receiving power, desired frequency-hopping pattern, and/or information indicating whether the frequency-hopping pattern of mobile station 1 contains an interference component. In accordance with the contents of the information, the base station 2 selects a frequency-hopping pattern suitable for the mobile station 1 (step S33), and informs the mobile station 1 of the selected frequency-hopping pattern (step S34). If there is no frequency-hopping pattern suitable for the mobile station 1, the base station 2 may inform the mobile station 1 of this. If the mobile station 1 receives a frequency-hopping pattern, it transmits data to the base station 2 within the term Tu (step S35). In contrast, if no frequency-hopping pattern is assigned to the mobile station 1, the mobile station 1 repeats the above-described process. If no frequency-hopping pattern is assigned to the mobile station 1 even after the mobile station 1 repeats the same process a predetermined number of times, the mobile station 1 assumes a standby state.

In the above-described fourth embodiment, since the base station manages all frequency-hopping patterns assigned to the mobile stations belonging to the service area of the base station, it can consider all frequency-hopping patterns that cannot be detected by each mobile station, and hence can realize more efficient frequency-hopping pattern control. Thus, the fourth embodiment can realize an appropriate communication state using the frequency-hopping multiplexing scheme.

### FIFTH EMBODIMENT

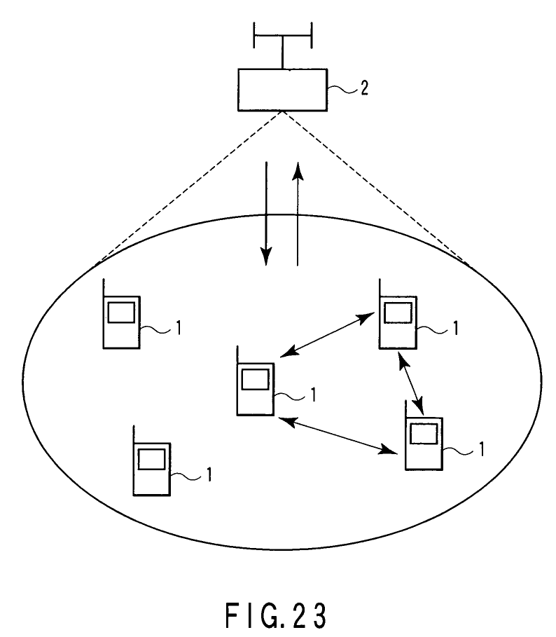

In the third and fourth embodiments, a base station and mobile station communicate with each other by radio. In contrast, in a fifth embodiment, adjacent mobile stations directly communicate with each other by radio. Specifically, FIG. 23 shows an example in which adjacent mobile stations 1 access each other via a radio channel that is usually used by radio communication from a mobile station to a base station.

Each mobile station 1 employed in the fourth embodiment has the same structure as that of the fourth embodiment shown in FIG. 16. Further, each mobile station 1 in FIG. 23 performs the same transmission start operation as that shown in FIG. 17 and the same transmission operation as that shown in FIG. 18. At step S25 in FIG. 17 and step S278 in FIG. 18, a frequency-hopping pattern is determined and changed with reference to frequency-hopping patterns acquired from other mobile stations.

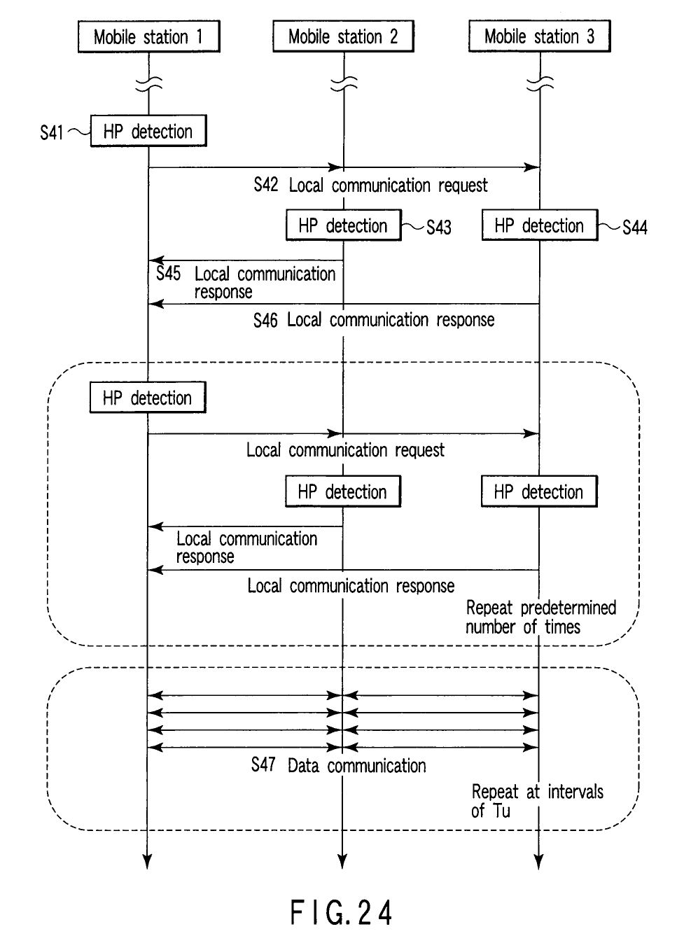

Referring to the sequence diagram of FIG. 24, a description will be given of the operations of mobile stations 1, 2 and 3 employed in the fifth embodiment.

A mobile station (mobile station 1) that tries to perform local communication detects frequency-hopping patterns used by other mobile stations at this time (step S41), determines, based on the detected patterns, a frequency-hopping pattern that can be used for local communication, and issues a request for local communication including the determined frequency-hopping pattern (step S42). When transmitting the local communication request, the mobile station (mobile station 1) may simultaneously transmit the detection result. In this case, each mobile station receiving the local communication request signal refers to the detection result to detect the frequency-hopping patterns used by other mobile stations.

Upon receiving the request, the mobile stations (mobile stations 2 and 3) detect the frequency-hopping patterns used by other mobile stations at this time, and determine whether the frequency-hopping pattern reported by the mobile station 1 can be used (steps S43 and S44). Further, the mobile stations 2 and 3 supply the mobile station 1 with a response including the determination result indicating whether local communication is possible (steps S45 and S46).

If the responses indicate that there is a mobile station with which local communication is possible, the mobile station 1 access the mobile station within the term Tu, using the reported frequency-hopping pattern (step S47). In contrast, if there is no such mobile station, the above-described process is repeated. If local communication is impossible even after the process is repeated a predetermined number of times, local communication is stopped.

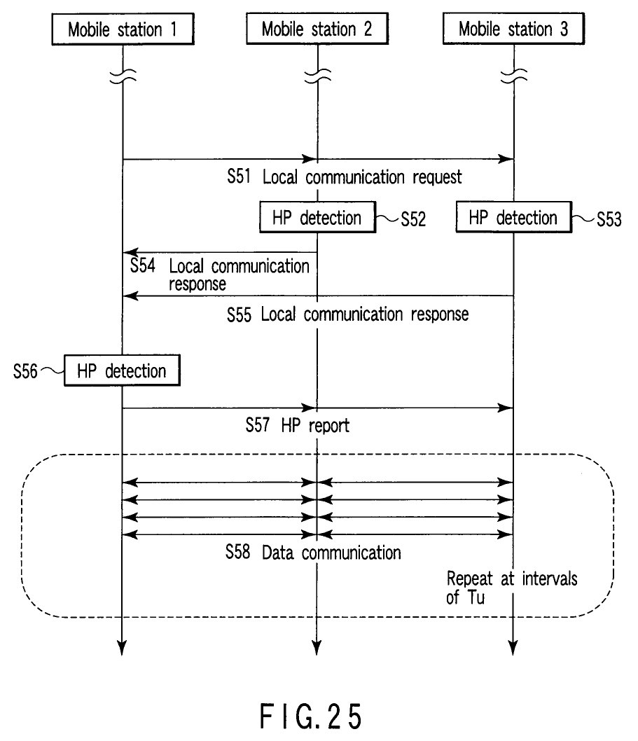

Referring to the sequence diagram of FIG. 25, a modification of the process shown in FIG. 24 will be described.

The modification shown in FIG. 25 differs from the process of FIG. 24 only in that in the former, the mobile station 1 detects frequency-hopping patterns after receiving local communication responses from other mobile stations (mobile stations 2 and 3). Specifically, in the case of FIG. 24, after frequency-hopping patterns are detected (step S41), a request for local communication is issued to other mobile stations (mobile stations 2 and 3) (step S42). On the other hand, in the modification of FIG. 25, before detecting frequency-hopping patterns, a request for local communication is issued to other mobile stations (mobile stations 2 and 3) (step S51). Frequency-hopping patterns are detected (step S56) after receiving local communication responses from the mobile stations (steps S54 and S55). Steps S43, S44, S45 and S46 in FIG. 24 are similar to steps S52, S53, S54 and S55. However, at steps S52 and S53, the mobile stations 2 and 3 cannot utilize the detection result of the mobile station 1 since they do not receive the detection result at these steps.

The mobile station that tries to perform local communication issues a request for local communication to a target mobile station. At this time, the target mobile station detects frequency-hopping patterns used by other mobile stations, determines therefrom a frequency-hopping pattern that can be used for local communication, and supplies the requester mobile station with a local communication response including the determination result.

The mobile station (mobile station 1) detects frequency-hopping patterns used by other mobile stations (mobile stations 2 and 3) at steps S54 and S55. From the detection results, the mobile station 1 determines frequency-hopping patterns that can be used for local communication, and compares the determined patterns with frequency-hopping patterns used by other mobile stations (mobile stations 2 and 3). If there are identical frequency-hopping patterns, the mobile station 1 reports this pattern to the mobile stations 2 and 3 (step S57), and performs local communication within the term Tu, using the frequency-hopping pattern (step S58).

In the above-described fifth embodiment, when performing local communication, all mobile stations as targets can use respective frequency-hopping patterns that do not interfere with each other, with the result that further reliable local communication can be realized. Thus, the fifth embodiment can establish an appropriate communication state using the frequency-hopping multiplexing scheme.

### SIXTH EMBODIMENT

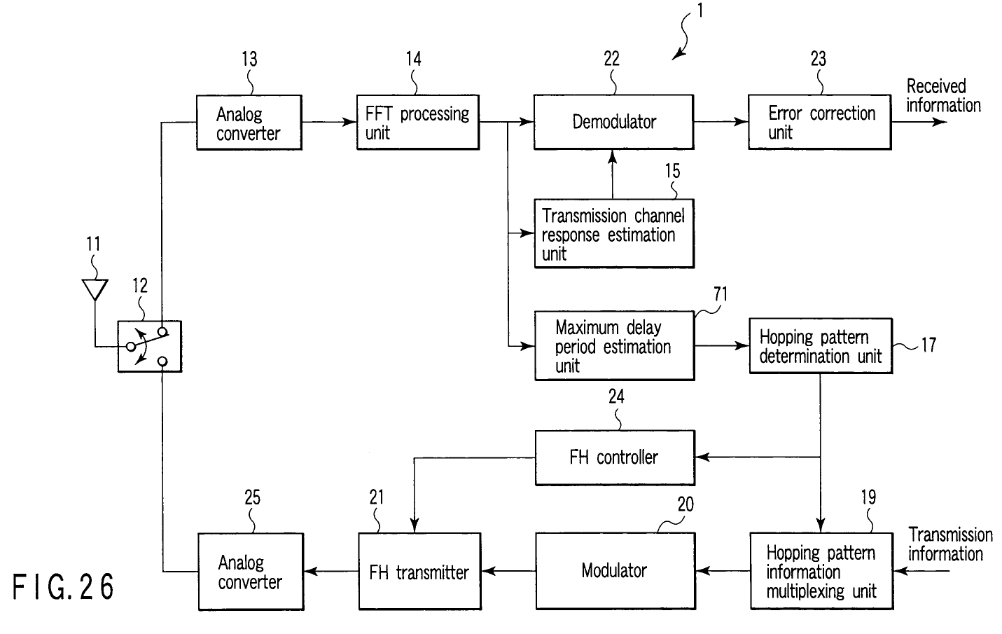

Referring to the block diagram of FIG. 26, a radio communication apparatus (mobile station 1) according to a sixth embodiment will be described.

The mobile station 1 of the third embodiment detects the frequency-hopping pattern of another mobile station 1. In contrast to this structure, the mobile station of the sixth embodiment estimates the maximum delay time of a delay wave contained in an OFDM signal received, and determines a frequency-hopping pattern based on the maximum delay time. In the third and sixth embodiments, like reference numeral denote like elements, and no description is given thereof. The mobile station 1 of the sixth embodiment has a maximum delay period estimation unit 71 instead of the power-measuring unit 61 of the third embodiment, and has no component corresponding to the hopping pattern storing unit 62. The other structures of the mobile station 1 of the sixth embodiment are similar to those of the mobile station 1 of the third embodiment shown in FIG. 16.

The maximum delay period estimation unit 71 estimates a maximum delay time as a channel response based on the baseband signal corresponding to the received OFDM signal, and outputs the estimated value to the hopping pattern determination unit 17.

The hopping pattern determination unit 17 selects a frequency-hopping pattern having a narrower hopping frequency interval than the inverse of the maximum delay time estimated by the maximum delay period estimation unit 71, and outputs it to the hopping pattern information multiplexing unit 19 and FH controller 24.

The hopping pattern information multiplexing unit 19 receives the frequency-hopping pattern determined by the hopping pattern determination unit 17, and multiplexes hopping pattern information indicating the frequency-hopping pattern and transmission information. However, if it is not necessary to transmit the hopping pattern information to the base station 2, multiplexing is not needed.

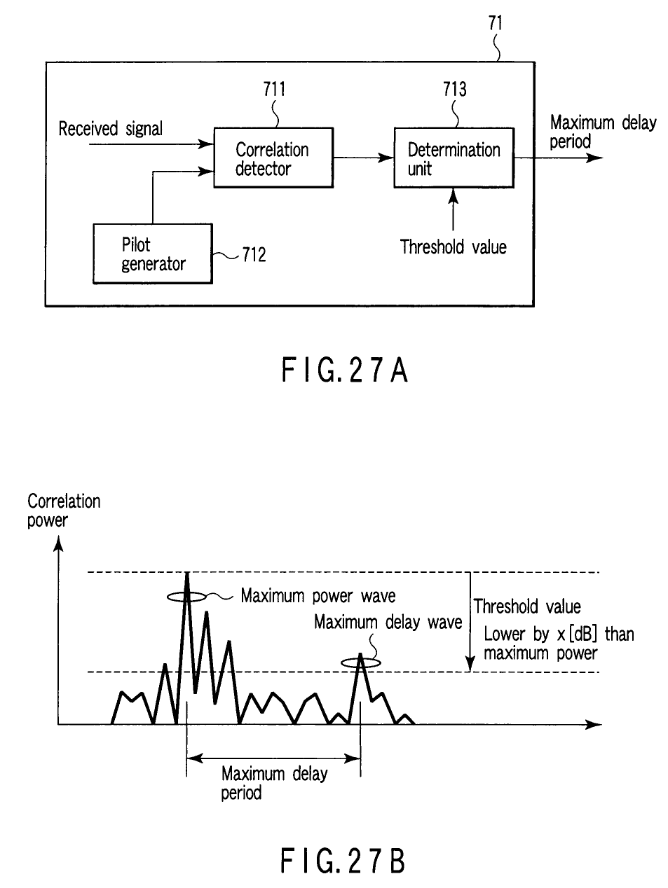

Referring to FIGS. 27A and 27B, a structure example of the maximum delay period estimation unit 71 will be described.

As shown in FIG. 27A, the maximum delay period estimation unit 71 comprises a correlation detector 711, pilot generator 712 and determination unit 713. The pilot generator 712 generates a time-dependent wave used for transmitting a known signal, which is contained as a format signal in a signal output from the base station 2. The correlation detector 711 detects correlation power between the time wave of a signal from the base station 2, and the time wave for the known signal generated by the pilot generator 712. FIG. 27B shows an example of a signal output from the correlation detector 711. The determination unit 713 determines the output signal of the detector 711 to be a delay signal if the output signal has power not less than a threshold level. The determination unit 713 outputs, as the maximum delay period, the period elapsing from the time at which a delay signal of the maximum power (the maximum power wave shown in FIG. 27B) is received, to the time at which a latest delay signal (the maximum delay wave shown in FIG. 27B). In FIGS. 27A and 27B, the threshold level is set to the level lower by ×[dB] than the maximum power level. However, the threshold level may be expressed by an absolute value.

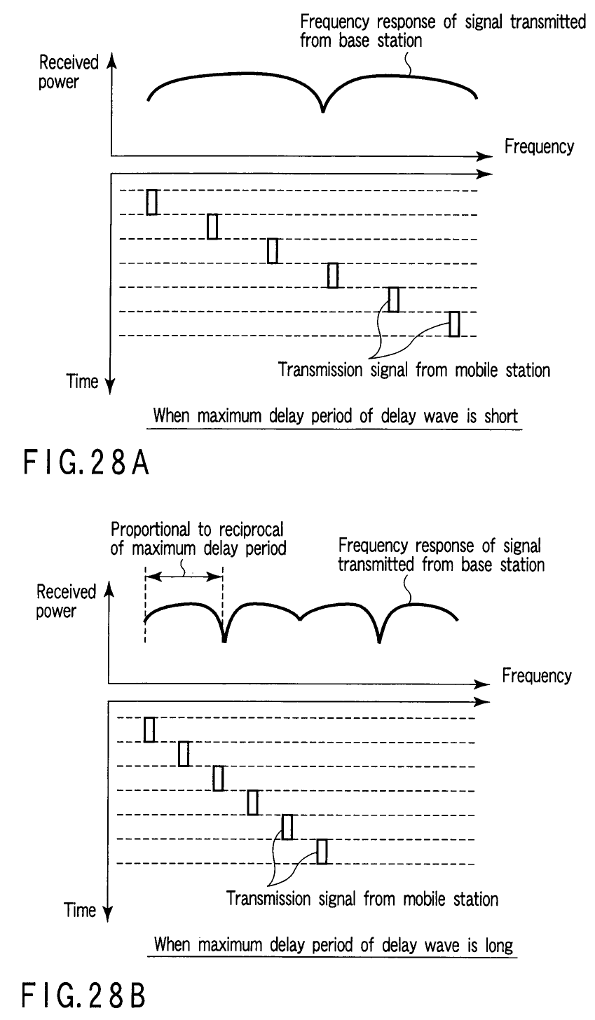

Referring then to FIGS. 28A and 28B, a description will be given of a frequency-hopping pattern determined by the hopping pattern determination unit 17 based on the maximum delay period. FIG. 28A shows a case where the maximum delay period is relatively short, while FIG. 28B shows a case where the maximum delay period is relatively long.

Where two same-type signals reach with a delay time therebetween, frequency selective fading occurs. Frequency selective fading indicates that the received power intensity of a signal depends upon frequency in the frequency band of the signal. Specifically, as shown in, for example, FIGS. 28A and 28B, the level of a received signal is observed to vary depending on frequency. As the maximum delay period is reduced, the interval of a drop in received signal level along the frequency axis is increased. For example, since the delay period in the case of FIG. 28A is shorter than that in the case of FIG. 28B, the interval of a drop in the received signal level is greater in FIG. 28A than in FIG. 28B.

Accordingly, where the range of frequency-base variations is relatively small as shown in FIG. 28A, the channel response estimated by the base station 2 does not substantially vary between adjacent FH signals even if the frequency interval used by the mobile station 1 for transmitting FH signals is set relatively small. In contrast, where the range of frequency-base variations is relatively large as shown in FIG. 28B, in order to set the channel response estimated by the base station 2 close between adjacent FH signals, it is necessary to narrow, in accordance with the variations, the frequency interval used by the mobile station 1 for transmission. In other words, in accordance with the maximum delay period of delay waves, it is necessary to increase the frequency interval between FH signals, transmitted by the mobile station 1, to a degree at which the channel response does not greatly vary between adjacent FH signals.

Utilizing the above, in the mobile station 1 of the sixth embodiment, the frequency-hopping interval used is controlled to be made proportional to the inverse of the maximum delay period, thereby enabling the propagation environment of the entire frequency band used by the base station 2 to be estimated within a minimum period corresponding to the propagation environment.

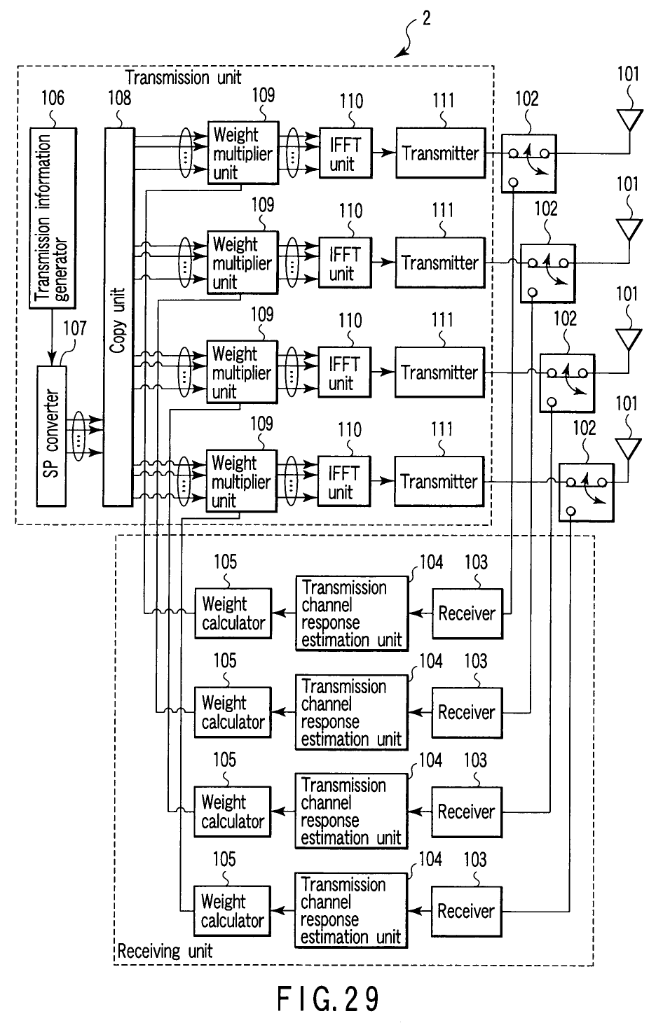

Referring to FIG. 29, an example of the base station 2 according to the sixth embodiment will be described.

The base station 2 shown in FIG. 29 is arranged to receive a signal from each mobile station 1, and has a beam-forming function. Beam forming is realized by controlling an orientation pattern using a weight multiplier unit 109. The base station 2 comprises four antenna elements 101, four antenna duplexers 102 corresponding to the antennal elements, a receiving unit and a transmitting unit. The receiving unit comprises four receivers 103, four transmission channel response estimation units 104 and four weight calculators 105, which correspond to the four antenna elements 101. The transmitting unit comprises a transmission information generator 106, a serial-to-parallel (SP) converter 107, a copy unit 108, four weight multiplier units 109, four inverse fast Fourier transformers (IFFT) 110 and four transmitters 111. The four weight multiplier units 109, four inverse fast Fourier transformers (IFFT) 110 and four transmitters 111 correspond to the four antenna elements 101.

Each receiver 103 receives an FH signal from the corresponding antenna element 101 via the corresponding antenna duplexer 102, down-converts it into a baseband signal, and outputs the baseband signal to the corresponding channel response estimation unit 104. The transmission channel response estimation unit 104 extracts a pilot signal from the baseband signal output from the corresponding receiver 103, estimates, from the pilot signal, the channel response of each sub-carrier in the corresponding antenna element 101, and outputs the estimated channel response vector to the corresponding weight calculator 105. The weight calculator 105 calculates a transmission weight (transmission weight vector) for each sub-carrier in the corresponding antenna element 101, based on the channel response vector, and outputs the transmission weight vector to the corresponding weight multiplier unit 109. As the transmission weight, the complex conjugate of the channel response vector of each antenna element may be used. Using such a weight, the ratio of the received power to the transmission power can be maximized. In the sixth embodiment, the weight is not limited to the complex conjugate.

The SP converter 107 performs serial-to-parallel conversion on the transmission data generated by the transmission information generator 106, and transmits, to the copy unit 108, a sub-carrier signal as the serial-to-parallel converted transmission data. The copy unit 108 copies the input sub-carrier signal, and outputs the copy of the sub-carrier signal to each weight multiplier unit 109. The sub-carrier signal output from the copy unit 108 is identical to that input to the copy unit 108. Each weight multiplier unit 109 multiplies the sub-carrier signal by the transmission weight vector calculated by the corresponding weight calculator 105, and outputs the resultant sub-carrier signal to the corresponding inverse fast Fourier transformer 110. The inverse fast Fourier transformer 110 performs inverse Fourier transform on the input sub-carrier signal, and outputs an OFDM signal. Thereafter, each transmitter 111 converts the corresponding OFDM signal into a radio frequency signal, and transmits it through the corresponding antenna element 101 via the corresponding antenna duplexer 102.

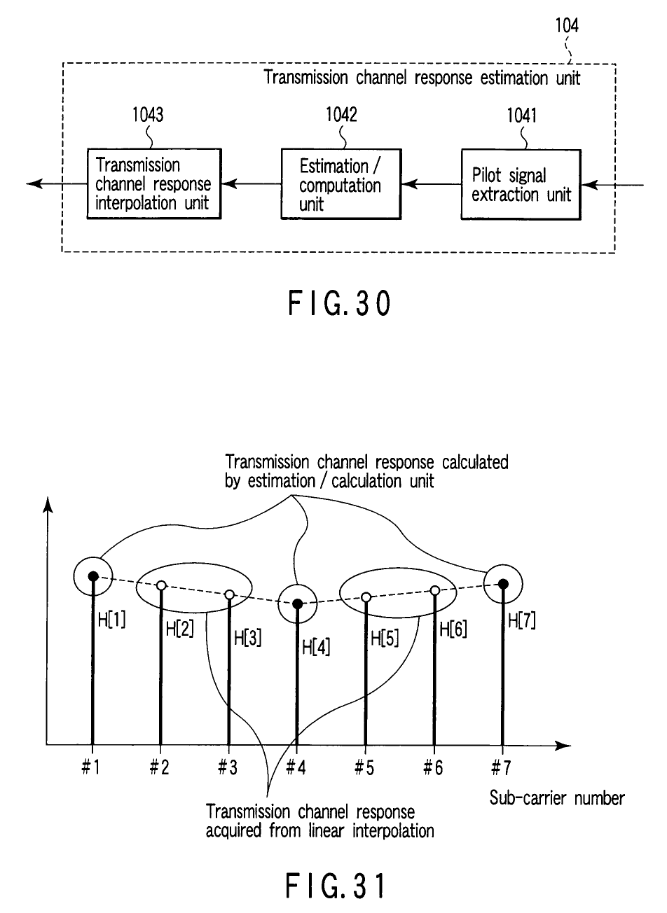

Referring to FIG. 30, a structure example of each transmission channel response estimation unit 104 will be described.

As shown, each transmission channel response estimation unit 104 comprises a pilot signal extraction unit 1041, estimation/computation unit 1042 and transmission channel response interpolation unit 1043. The pilot signal extraction unit 1041 extracts a pilot signal from a baseband signal into which an FH signal received by each receiver 103, and outputs it to the estimation/computation unit 1042. Based on the input pilot signal, the estimation/computation unit 1042 estimates a channel response value at a frequency with which the FH signal is carried. The transmission channel response interpolation unit 1043 performs interpolation processing on the channel response vector estimated by the estimation/computation unit 1042, thereby computing and outputting channel response values at frequencies that were not estimated by the estimation/computation unit 1042. As a result, the unit 1043 outputs the estimated channel response vector of all sub-carriers.

Referring to FIG. 31, a description will be given of channel response examples estimated by the transmission channel response estimation unit 104.

In FIG. 31, assume that the base station 2 receives three FH signals transmitted at the same transmission frequency bands as those of sub-carriers with numbers 1, 4 and 7 included in an OFDM signal. Assume that the smaller the number assigned to the sub-carrier, the lower the frequency of the sub-carrier. Assume further that the estimated channel response value of the k^{th} sub-carrier is represented by H[k], and the Fourier-transformed values of the transmission and reception waveforms of the pilot signal of an FH signal transmitted at the same frequency as that of the k^{th} sub-carrier are represented by X[k] and Y[k], respectively. In this case, channel response vector H is given by H=[H[1], H[4], H[7]]=[Y[1]/X[1], Y[4]/X[4], Y[7]/X[7]]. The channel response estimation method is not limited to the method using the above equation.

Based on H [1], H [4], H [7], the transmission channel response interpolation unit 1043 acquires, by linear interpolation, channel response values H[2], H[3], H[5] and H[6]. Specifically, the transmission channel response interpolation unit 1043 acquires H[2] and H[3] by interpolation, based on the straight line determined from H[1] and H[4], and similarly acquires H[5] and H[6] by interpolation, based on the straight line determined from H[4] and H[7]. Although linear interpolation is utilized here, a method other than linear interpolation may be utilized to interpolate channel response values.

As described above, in the system of the sixth embodiment that is formed of mobile stations 1 and a base station 2 having a beam-forming function, each mobile station appropriately thins out hopping bands in accordance with the maximum propagation delay period. Further, the base station estimates the channel response values of all sub-carriers by performing interpolation on already estimated channel response values. Accordingly, the weights used for down-signal beam forming can be determined without hopping FH up-signals over the entire range corresponding to all sub-carriers. Further, the use of a frequency-hopping pattern having hopping frequency intervals narrower than the inverse of the maximum delay period of a channel response can reduce the error in channel response estimated by interpolation.

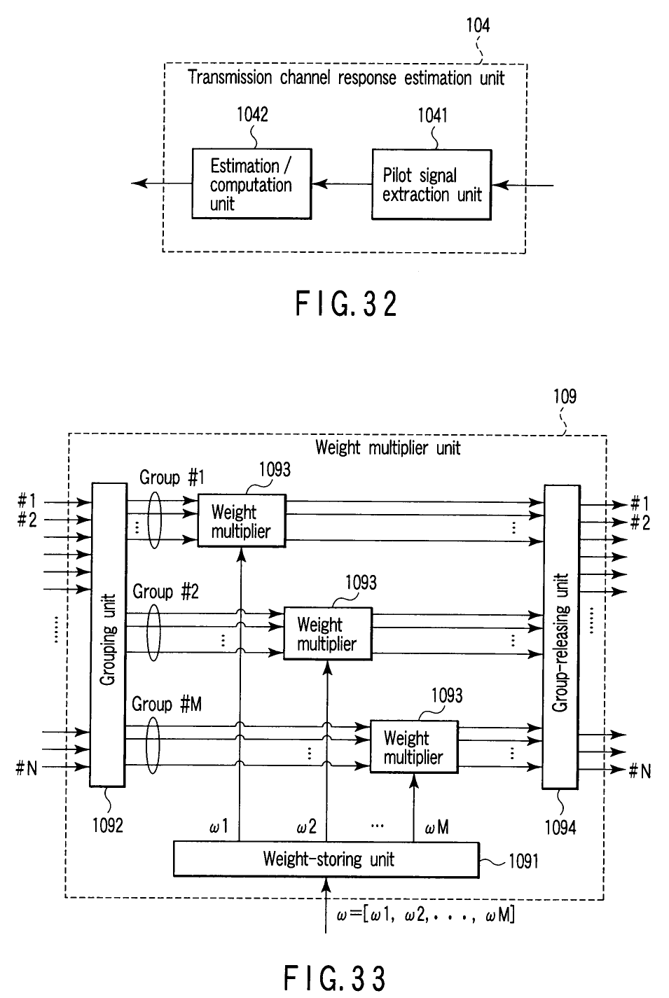

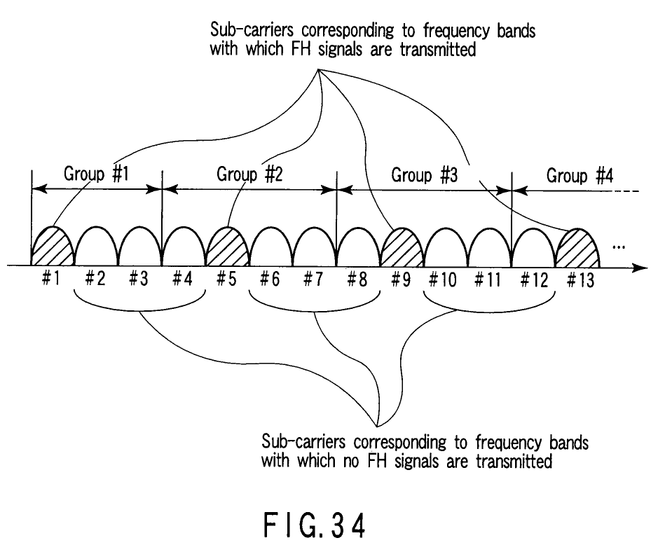

Referring to FIG. 32, a modification of the transmission channel response estimation unit 104 shown in FIG. 30 will be described. Referring further to FIG. 33, a weight multiplier unit 109 employed when the transmission channel response estimation unit 104 of FIG. 32 is used will be described.

The transmission channel response estimation unit 104 of FIG. 32 comprises a pilot signal extraction unit 1041 and estimation/computation unit 1042. The estimation unit 104 of FIG. 32 differs from the estimation unit 104 of FIG. 30 in that in the former, interpolation of channel response values is not performed, and only the channel response at a frequency with which the received FH signal is carried is calculated. In other words, the estimation unit 104 of FIG. 32 is acquired by removing the transmission channel response interpolation unit 1043 from the estimation unit 104 of FIG. 30

As shown in FIG. 33, each weight multiplier unit 109 in the base station 2 comprises a weight-storing unit 1091, a grouping unit 1092, the same number of weight multipliers 1093 as the groups grouped by the grouping unit 1092, and a group-releasing unit 1094. The weight-storing unit 1091 stores a transmission weight vector acquired by the corresponding weight calculator 105, and outputs each component of the transmission weight vector to the corresponding weight multiplier 1093. The grouping unit 1092 groups sub-carrier signals into the same number of groups (with group numbers #1, #2, . . . , #M) as the elements M of the transmission weight vector, and outputs the groups to the respective weight multipliers 1093. Each weight multiplier 1093 multiplies the input signal sequence by a weight, and outputs signals to the group-releasing unit 1094. The group-releasing unit 1094 releases the group signals into signals corresponding to the original sub-carrier signals.

As shown in FIG. 33, if transmission weight vector ω is ω=[ω1, ω2, . . . , ωM], the grouping unit 1092 groups sub-carrier signals into M groups with group numbers #1, #2, . . . , #M. Upon receiving a sub-carrier signal group with group number #1, the weight multiplier 1093 multiplies this group by weight ω1. The resultant sub-carrier group is input to the group-releasing unit 1094. Similar processing is performed on the other sub-carrier signal groups with group numbers #2, . . . , #M.

FIG. 33 shows an example of grouping of sub-carrier signals by the grouping unit 1092. In this example, grouping is performed under the following three conditions:

1) Each group contains only one of the sub-carriers corresponding to the frequency bands with which FH signals are transmitted;

2) Sub-carrier signals belonging to each group have serial numbers; and

3) All sub-carrier signals belong to the groups.

As described above, in the base station 2 incorporating the transmission channel response estimation unit 104 of FIG. 32 and weight multiplier unit 109 of FIG. 33, the frequency-hopping bands used by the mobile stations are thinned out. Therefore, the weight calculators 105 calculate weights, used for down-signal beam forming, in a state where it is not necessary to estimate the channel response values of all sub-carriers. Thus, in the radio communication system of the sixth embodiment, the weights used for down-signal beam forming can be determined so as not to make FH up-signals hop over all frequency bands corresponding to all sub-carriers. Further, since the sub-carriers belonging to the same group is multiplied by the same weight, the weight calculators do not have to calculate weights for all sub-carriers, resulting in a reduction in the amount of calculation. Moreover, since a frequency-hopping pattern having a hopping frequency interval narrower than the inverse of the maximum delay period in a channel response is used, a calculation error in weight due to grouping can be minimized. As a result, the sixth embodiment can realize an appropriate communication state using frequency-hopping multiplexing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus for receiving an orthogonal frequency division multiplexing (OFDM) signal from a base station and transmitting a frequency hopping (FH) signal to the base station, using a plurality of sub-channels, the base station comparing a plurality of hopping pattern information items indicating hopping patterns from a plurality of radio communication apparatuses including the radio communication apparatus, and generating collision information when the hopping patterns include colliding hopping patterns, the apparatus comprising:
an estimation unit configured to estimate a plurality of channel response values of the sub-channels based on the OFDM signal;
a selector which selects, from the sub-channels, several sub-channels which have higher channel response values than a value, each of the channel response values being expressed by a power level, a signal-to-noise power ratio, or a signal-to-interference ratio;
a determination unit configured to determine a hopping pattern from the selected sub-channels;
a transmitter which transmits, to the base station, a hopping pattern information item indicating the determined hopping pattern;
a receiver which receives the collision information from the base station; and
a correction unit configured to correct the hopping pattern based on the collision information.

2. The apparatus according to claim 1, wherein the estimation unit decomposes the OFDM signal into a plurality of components for each of frequency bands, and estimates the channel response values from an amplitude and a phase corresponding to a received signal power level of the OFDM signal at each frequency band.

3. A radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, using a plurality of sub-channels, the system comprising:
each of the radio communication apparatuses comprising:
an estimation unit configured to estimate a plurality of channel response values of the sub-channels based on the OFDM signal;
an acquisition unit configured to acquire a plurality of received signal levels for each of frequency bands from the estimated channel response values;
a selector which selects, from the sub-channels, several sub-channels which have higher received signal levels than a value, each of the channel response values being expressed by a power level, a signal-to-noise power ratio, or a signal-to-interference ratio;
a determination unit configured to determine a hopping pattern from the selected sub-channels; and
a transmitter which transmits, to the base station, hopping pattern information indicating the determined hopping pattern,
the base station comprising:
a receiver which receives the hopping pattern information from each of the radio communication apparatuses;
a generator which generates collision information when detecting colliding hopping patterns which exist between the radio communication apparatuses, by comparing a plurality of hopping pattern information items from the radio communication apparatuses; and
a transmitter which transmits the collision information to each of the radio communication apparatuses,
each of radio communication apparatuses further comprising:
a receiver which receives the collision information from the base station; and
a correction unit configured to correct the determined hopping pattern based on the collision information.

4. The system according to claim 3, wherein the generator generates, as the collision information, number of colliding sub-channels in a period in which each sub-channel is used, number of collisions of each sub-channel in the period, or number of collisions of each channel group which includes several of the sub-channels.

5. The system according to claim 3, wherein the transmitter of each of the radio communication apparatuses transmits the hopping pattern information to the base station, using a dedicated sub-channel included in the sub-channels.

6. The system according to claim 3, wherein:
the correction unit replaces a used sub-channel with a unused sub-channel, if number of colliding sub-channels is not less than a value in a period in which the used sub-channel is used, and/or if number of collisions of the used sub-channel in the period is not less than a value; and
the correction unit alternatively replaces, with an unused sub-channel, at least one sub-channel included in a sub-channel group, if number of colliding sub-channels is not less than a value in a period in which the at least one sub-channel included in sub-channel groups including the sub-channel group is used, and/or if number of collisions of the at least one sub-channel included in the sub-channel groups in the period is not less than a value.

7. The system according to claim 6, wherein the correction unit uses, for replacement, one of unused sub-channels which has a best channel response value.

8. A radio communication apparatus for receiving an orthogonal frequency division multiplexing (OFDM) signal from a base station, and transmitting a frequency hopping (FH) signal to the base station, the apparatus comprising:
a storing unit configured to store a plurality of hopping patterns which are suitable for use;
a measuring unit configured to measure a received signal characteristic of each sub-carrier included in the OFDM signal;
an acquiring unit configured to acquire, from the storing unit, one of the hopping patterns which uses a frequency band determined to be unused from the received signal characteristic; and
a transmitter which transmits a signal in accordance with the acquired hopping pattern.

9. The apparatus according to claim 8, wherein the measuring unit decomposes the OFDM signal into components for each of frequency bands, measures a received signal power level of each of the components, and estimates a plurality of channel response values of each of the components from an amplitude and a phase corresponding to a received signal power level of the OFDM signal at each frequency band.

10. The apparatus according to claim 9, wherein the measuring unit determines that each of the components is used if the received signal power level of each of the components is higher than a first threshold value, the measuring unit determining that each of the components is unused if the received signal power level of each of the components is lower than a second threshold value, the second threshold value being lower than the first threshold value.

11. The apparatus according to claim 8, wherein the acquiring unit acquires, from the hopping patterns, a hopping pattern including sub-carriers which are determined to be unused with temporal continuity.

12. A radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, the system comprising:
each of the radio communication apparatuses comprising:
a measuring unit configured to measure a received signal characteristic of each sub-carrier included in the OFDM signal; and
a transmitter which transmits the measured received signal characteristic to the base station,
the base station comprising:
a receiver which receives the transmitted received signal characteristic from each of the radio communication apparatuses;
a storing unit configured to store a plurality of hopping patterns which are suitable for use;
an acquiring unit configured to acquire, from the storing unit, one of the hopping patterns which uses a frequency band determined to be unused from the received signal characteristic; and
a transmitter which transmits, to each of the radio communication apparatuses, hopping pattern information indicating the acquired hopping pattern.

13. A radio communication apparatus for receiving an orthogonal frequency division multiplexing (OFDM) signal from a base station, and transmitting a frequency hopping (FH) signal to the base station, the apparatus comprising:
a measuring unit configured to measure a received signal characteristic of each sub-carrier included in the OFDM signal;
a storing unit configured to store a plurality of hopping patterns which are suitable for use;
an acquiring unit configured to acquire, from the storing unit, one of the hopping patterns which uses a frequency band determined to be unused from the received signal characteristic; and
a transmitter which transmits, to another radio communication apparatus, a signal for requesting communication using the acquired hopping pattern.

14. The apparatus according to claim 13, further comprising:
a receiver which receives, from said another radio communication apparatus, a response signal indicating whether communication using the acquired hopping pattern is possible; and
a communication unit configured to communicate with said another radio communication apparatus if the response signal indicates that the communication is possible.

15. A radio communication apparatus for receiving an orthogonal frequency division multiplexing (OFDM) signal from a base station, and transmitting a frequency hopping (FH) signal to the base station, the apparatus comprising:
a transmitter which transmits, to another radio communication apparatus, a request signal to request hopping pattern information indicating a hopping pattern used by said another radio communication apparatus;
a receiver which receives the hopping pattern information from said another radio communication apparatus;
a measuring unit configured to measure a received signal characteristic of each sub-carrier included in the OFDM signal;
a storing unit configured to store a plurality of hopping patterns which are suitable for use;
an acquiring unit configured to acquire, from the storing unit, a plurality of hopping patterns which uses a plurality of frequency bands determined to be unused from the received signal characteristic; and
an informing unit configured to inform said another radio communication apparatus that communication is performed using a common hopping pattern, if the common hopping pattern is determined to exist between the acquired hopping patterns and the hopping pattern information.

16. A radio communication apparatus for receiving an orthogonal frequency division multiplexing (OFDM) signal from a base station, and transmitting a frequency hopping (FH) signal to the base station, the apparatus comprising:
an estimation unit configured to estimate a maximum delay period of a delay wave contained in the OFDM signal;
a determination unit configured to determine a hopping pattern to enlarge intervals between sub-channels in proportion to an inverse of the maximum delay period; and
a transmitter which transmits data to the base station using the determined hopping pattern.

17. The apparatus according to claim 16, wherein the estimation unit includes:
a generator which generates a time-dependent wave of a known signal contained in the OFDM signal;
a detector which detects a correlation power level between a time-dependent wave of the OFDM signal and the time-dependent wave of the known signal; and
a measuring unit configured to measure a period ranging from a time at which a delay wave of a maximum power level occurs, to a time at which a maximum delay wave occurs, the delay wave of the maximum power level and the maximum delay wave having the correlation power level not less than a level.

18. A radio communication system including a base station for transmitting an orthogonal frequency division multiplexing (OFDM) signal, and a plurality of radio communication apparatuses for receiving the OFDM signal from the base station and transmitting a frequency hopping (FH) signal to the base station, using a plurality of sub-channels, the system comprising:
each of the radio communication apparatuses comprising:
an estimation unit configured to estimate a maximum delay period of a delay wave contained in the OFDM signal;
a determination unit configured to determine a hopping pattern to enlarge intervals between the sub-channels in proportion to an inverse of the maximum delay period; and
transmitter which transmits data to the base station using the hopping pattern,
the base station comprising:
a receiver which receives a signal transmitted from said each of the radio communication apparatuses using the hopping pattern;
an estimation unit configured to estimate a plurality of channel response values based on the received signal;
a calculator which calculates a plurality of weights for sub-carrier signals to be transmitted, based on the channel response values; and
a multiplication unit configured to multiply the sub-carrier signals by corresponding weights.

19. The apparatus according to claim 18, wherein the estimation unit includes:
an estimation element configured to estimate a channel response value at a frequency band corresponding to the received signal; and
an interpolation unit configured to acquire, by interpolation, a plurality of channel response values at non-estimated frequency bands from the channel response values.

20. The apparatus according to claim 18, wherein the multiplication unit includes:
a grouping unit configured to group the sub-carrier signals into signals, number of which is same number of groups as number of the calculated weights;
a plurality of multipliers which multiply the groups of sub-carrier signals by corresponding weights; and
a restoration unit configured to restore signals output from the multipliers, to signals corresponding to the sub-carrier signals.
